(19) United States
(12) Patent Application Publication
(10) Pub. No.: US 2024/0301264 A1
(43) Pub. Date: Sep. 12, 2024

(54) Thermally Conductive Electrically Resistive Low Density Adhesive

(71) Applicant: Zephyros, Inc., Romeo, MI (US)

(72) Inventors: Dietmar Golombowski, Molsheim Cedex (FR); Peter Cate, Gloucestershire (GB)

(21) Appl. No.: 18/268,151

(22) PCT Filed: Dec. 16, 2021
(86) PCT No.: PCT/EP2021/086125

§ 371 Date: Jun. 16, 2023

(30) Foreign Application Priority Data
Dec. 17, 2020 (EP) 20215043.9
Feb. 24, 2021 (EP) 21158971.8

(51) Int. Cl. C09J 183/06; B60L 58/26; C08K 3/04; C08K 3/22; C08K 3/26; C08K 3/38; C09J 5/00; H01M 10/613; H01M 10/625; H01M 10/653; H01M 10/6554

(52) U.S. Cl. CPC C09J 183/06; B60L 58/26; C09J 5/00; H01M 10/613; H01M 10/625; H01M 10/653; H01M 10/6554; C08K 3/042; C08K 2003/2227; C08K 2003/265; C08K 2003/385; C09J 2203/33; C09J 2301/408; C09J 2483/00; H01M 2220/20

(57) ABSTRACT

The invention relates to a curable composition comprising (i) humidity-curable prepolymer such as a humidity-curable polyurethane, silicone or polysulfone prepolymer; (ii) thermally conductive nano-filler selected from graphene, graphene oxide, carbon nanotubes, and mixtures thereof; (iii) optionally, another thermally conductive nano-filler; and (iv) optionally, thermally conductive macro-filler. The composition combines high thermal conductivity with high electrical resistivity and low density. The composition is particularly useful for adhering bottom plates of battery casings to metal parts of vehicles and ensures excellent heat transfer from the battery to the environment.

Priority is claimed of European patent application no. 20 215 043.9, which was filed on Dec. 17, 2020, and of European patent application no. 21 158 971.8, which was filed on Feb. 24, 2021.

The invention relates to a curable composition comprising (i) humidity-curable prepolymer, such as a humidity-curable polyurethane, silicone or polysulfone prepolymer, preferably a silyl-modified prepolymer, more preferably a silyl-modified polyether or copolyether; (ii) thermally conductive nano-filler, preferably graphene, graphene oxide, carbon nanotubes, or a mixture thereof, (iii) optionally, another thermally conductive nano-filler; and (iv) optionally, thermally conductive macro-filler. The composition combines high thermal conductivity with high electrical resistivity and low density. The composition is particularly useful for adhering casings of battery elements to metal parts, e.g. bottom plates of vehicles and ensures excellent heat transfer from the battery to the environment.

Batteries of electric vehicles typically contain a multitude of battery cells storing electrical energy for the engine. The battery cells may be recharged prior to driving or also during driving, e.g. by regenerating braking energy or by producing electrical power by means of an internal combustion engine. During recharging, exothermic reactions taking place inside the battery cells produce heat. As the time that is needed for recharging of battery cells is critical and should be as short as possible, modern recharging processes aim at loading the battery cells at very high electrical power often exceeding 10 kW. In consequence, considerable heat is produced during recharging.

For security reasons and also for enhancing battery efficiency and longevity, it is desirable to maintain the temperature of the battery cells constant, preferably at about 25° C. If the batteries of electric vehicles are overheated, the battery cells may deform thereby destroying fragile internal structures such as membranes. As a consequence, internally developed shorts may result in combustion or explosion of vaporized battery gas. Accordingly, thermal management of the battery cells of electric vehicles is necessary not only to achieve optimal battery performance but also to meet safety standards of electric vehicles.

In order to avoid overheating, the heat produced during recharging needs to be dissipated to the environment. This can be achieved by contacting the casing of the battery cells with metal parts of the chassis of the vehicle and/or metal parts of heatsinking elements or cooling plates, i.e. passive heat exchangers. To ensure efficient heat transfer from the battery cells to the metal parts, thermal interface materials are conventionally used to provide an intimate contact between the casing of the battery cells and the metal parts.

Thermal interface materials used for this purpose should sufficiently adhere the heavy battery cells to the metal parts. Nonetheless, as battery lifetime can be limited, the thermal interface materials should allow for easy repair and also for removing the battery cells from the vehicle in order to replace them by new battery cells. When replacing the battery cells, it would be desirable to only remove the old battery cells along with their casing, but not the thermal interface materials from the vehicle, and to then fix the new battery cells to the metal parts by reusing the thermal interface materials that have remained in the vehicle. It would be desirable to have a thermal interface material that provides sufficient rebonding to properly connect the new replacement battery element to the cooling plate, without addition of further thermal interface material. This debonding/rebonding would be advantageous because it allows aftermarket servicing without additional application of thermal interface material. This would avoid the risk of insufficient or too much thermal interface material, the risk of damage to adjacent battery elements, capital equipment for dispensing, and the like.

Further, thermal interface materials used for this purpose should be capable of filling various gaps corresponding to the difference in dimensions of battery cells and metal parts. Thus, thermal interface materials having not only high thermal conductivity, but also high flexibility and easy handling are desired.

Still further, thermal interface materials used for this purpose should not only exhibit a very high thermal conductivity in order to provide efficient heat transfer. In view of the high energy density within the battery cells, they should at the same time have a low electrical conductivity, i.e. a high electric resistivity, in order to provide electrical isolation between the battery cells and the chassis of the vehicle and other metal parts.

Yet further, thermal interface materials used for this purpose should not add significant weight to the vehicle, i.e. should have a low density. With low density thermal interface materials, weight savings of about 5 to 10 kg appear possible compared to conventional thermal interface materials.

Various thermal interface materials are known from the prior art and have been developed essentially for electronics industry where electronic elements such as transistors are the heat source. Some materials can be based upon epoxy chemistry, others on polyorganosiloxanes.

B. Tang et al., International Journal of Heat and Mass Transfer, 2015, 85, 420-429 relates to the application of graphene as filler to improve thermal transport property of epoxy resin for thermal interface materials. J. Gao et al., Fibers and Polymers, 2015, 16(12), 2617-2626 report about enhanced thermal properties for epoxy composites with a three-dimensional graphene oxide filler. R. Atif et al., Polymers, 2016, 8, 281, 1-37 review mechanical, thermal, and electrical properties of graphene-epoxy nanocomposites.

US 2011 0311767 A1 discloses curable composition containing (A) a polyorganosiloxane base polymer having an average per molecule of at least two aliphatically unsaturated organic groups, optionally (B) a crosslinker having an average per molecule of at least two silicon bonded hydrogen atoms, (C) a catalyst, (D) a thermally conductive filler, and (E) an organic plasticizer. The composition can cure to form a thermally conductive silicone gel or rubber. The thermally conductive silicone rubber is said to be useful as a thermal interface material, in both TIM1 and TIM2 applications.

P. S. Shah et al., International Journal of Engineering Research & Technology (IJERT), 2019, 8(9) review graphene as fillers in rubber nano-composites.

Thermal interface materials used in electronic devices, however, are small scale and light weight. Those thermal interface materials used in small electronic devices to date have not been capable of being used on larger heat sources. Larger heat sources, such as the electric vehicle batteries, require different thermal interface materials having different properties. For example, the flow properties and viscosity of thermal interface materials must be modified when used with a larger heat source such as an electric vehicle battery. Further, the useful dispense rate of the thermal interface material used on a large heat source will be different than that of a thermal interface material used on a small heat source.

Further, as far as epoxy-based thermal interface materials are concerned, they are comparatively brittle and difficult to repair. Further, replacing battery cells that are adhered to metal parts of a vehicle by means of epoxy-based thermal interface materials can be difficult. When trying to remove the battery cells, the adherence of the epoxy-based thermal interface materials to the casing of the battery cells (usually made from thermoplastic polymers) is typically stronger than that to the metal parts of the vehicle. If adhesive failure can be achieved at all, it thus likely occurs at the interface to the metal parts of the vehicle, but not, as would be desirable, at the interface to the casing of the battery cells. The same can be expected for polyurethane-based thermal interface materials.

Thermal interface materials have also been developed for battery applications in vehicles specifically.

US 2017 0200995 A1 relates to methods and devices for providing an even distribution of waste heat in a vehicular battery pack, including a battery pack, a cold plate, a coolant reservoir, a support structure between the battery pack and the coolant reservoir, and a conformable thermal interface material for filling the space between cells of the battery pack and the coolant reservoir so as to provide thermal contact between the cells and the coolant reservoir for distributing the waste heat.

US 2017 0362473 A1 relates to adhesives, preferably hot melt adhesives, with improved thermal conductivity, uses thereof and methods for the manufacture of composites with improved thermal conductivity using said adhesive compositions. The composition comprises three fillers and at least one (co)polymer, selected from the group consisting of thermoplastic polyamides, alpha-olefins, poly(meth)acrylates, thermoplastic polyurethane, polyesters, ethylene copolymers, ethylene vinyl copolymers, styrenic block copolymers, PLA, copolyamides, silicones, epoxies, polyols or combinations thereof.

US 2020 0243926 A1 discloses a thermal interface member that may comprise a substrate having a first surface and an opposite second surface, an electrically conductive layer disposed on the first surface of the substrate, and an electrically resistive layer disposed on the first surface of the substrate. The substrate may comprise a compliant electrically insulating and thermally conductive material including a polymeric matrix phase and a dispersed phase of thermally conductive particles. The polymeric matrix phase of the substrate may comprise at least one of a silicone-, siloxane-, epoxy-, acrylicalkyd-, polyisobutylene-, polyurethane-, polyvinylidene-, polycycloolefin-, or cyclooctene-based material. The dispersed phase of thermally conductive particles may comprise at least one of boron nitride, alumina, silicon nitride, silicon carbide, aluminum nitride, diamond, synthetic diamond, or expanded graphene. The conductive layer comprises at least one of copper (Cu), gold (Au), silver (Ag), aluminum (Al), nickel (Ni), zinc (Zn), carbon (C), graphite, or graphene.

WO 2020 176612 A1 relates to a thermally conductive curable composition comprising a first part and a second part, wherein the first part comprises a catalyst, a ceramic filler mixture, a low volatile organic liquid, and water, wherein the second part comprises a silyl modified reactive polymer, a low volatile organic liquid, and a ceramic filler mixture, and wherein the low volatile organic liquid is present in the composition in an amount of >50 wt.-% based on the total weight of the silyl modified reactive polymer. The ceramic filler mixture is preferably present in each of the first part and the second part in an amount from about 80 wt.-% to about 95 wt.-%, for example about 90-92 wt.-%, based on the total weight of each of the first part and the second part resulting in a high density material.

CN 106 117 714 A discloses a titanium sol modified geogrid, made from the following materials according to parts by weight: 2-3 parts of aluminum nitride powder, 10-17 parts of polypropyleneimine, 6-8 parts of tert-butyl acrylate, 0.1-0.3 part of lithium aluminum hydride, 0.3-1 part of 3,4-dimethylamino-pyridine, 0.4-1 part of antioxidant 1010, 10-15 parts of multi-walled nanotubes, 0.6-1 part of antioxidant 168, 140-160 parts of high-density polyethylene, 1-2 parts of sodium lignosulfonate, 4-7 parts of butyl benzyl phthalate, 0.04-0.1 part of dibasic lead phosphite, 1-2 parts of triethanolamine, 3-4 parts of microcrystalline wax, 0.6-1 part of silane coupling agent kh560, and 3-4 parts of tetrabutyl titanate. The antioxidants 1010 and 168 can be jointly used to eliminate alkyl radicals, peroxy radical, alkoxy radicals and hydroperoxides, the content of free radicals engaging in polymer automatic oxidative chain reaction is said to be greatly decreased, polymer oxidative degrading process is retarded, and oxidation resistance of the finished material is prolonged.

M. May et al., Journal of Coatings Technology and Research, vol. 13, no. 2, 2016, 325-332 reports that the tensile shear strength of a composite epoxy/sol-gel system modified with different ratios of multiwall carbon nanotubes (MWCNTs) was evaluated using mechanical testing machine.

The thermal interface materials of the prior art are not satisfactory in every respect.

Conventional thermal interface materials (TIM) are either based on polyurethane, epoxy or silicone material base. They are also usually filled with traditional thermally conductive fillers at very high volume up to 80%. The volume price of such materials is comparatively high. Further, such materials typically have a high density and thus add considerable weight when used e.g. in a vehicle. These materials are typically brittle, do not adhere well to non-primed aluminum (i.e. cooling plate material), are moisture sensitive (both in storage, during application and in service) and contain toxic substances such as isocyanates or phthalates.

There is a demand for improved thermal interface materials that can be advantageously used for heat transfer from battery cells of vehicles.

It is an object of the invention to provide thermal heat transfer materials (thermal interface materials, TIM) having advantages compared to the prior art. The thermal heat transfer materials should have a high thermal conductivity, but at the same time also a high electrical resistivity as well as a low density. Further, the thermal heat transfer materials should be non-toxic, safe, and meet safety standards of electric vehicles. Still further, the thermal heat transfer materials should be easy to handle, e.g. not require mixing two or more components prior to use, and should be easy to repair. Furthermore, the thermal heat transfer materials should sufficiently adhere and fix the casings of the battery cells but also facilitate exchanging battery cells after expiry of lifetime.

This object has been achieved by the subject-matter of the patent claims.

It has been surprisingly found that based upon (i) humidity-curable polymer such as a humidity-curable polyurethane, silicone or polysulfone prepolymer, preferably silyl-modified prepolymer, and (ii) thermally conductive nano-filler selected from graphene, graphene oxide, carbon nanotubes and mixtures thereof, preferably having an average particle size (ASTM B330—2) of less than 1.0 μm (1000 nm), curable compositions can be prepared that have various advantageous properties. In particular, the curable composition according to the invention exhibits excellent thermal conductivity at low density and high electric resistivity. Matrix materials other than silyl-modified polymers (SMP) show less efficiency on thermal conductivity when being paired with the corresponding quantities of thermally conductive nano-filler and optionally thermally conductive macro-filler, preferably having an average particle size (ASTM B330—2) of at least 1.0 μm (1000 nm).

At comparatively low levels of thermally conductive nano-filler, optionally in combination with comparatively low levels of thermally conductive macro-fillers, thermal conductivities of greater than about 1.7 W·m⁻¹·K⁻¹ and preferably 3.0 W·m⁻¹·K⁻¹ can be achieved at significantly lower densities compared to conventional thermal heat transfer materials, preferably at densities within the range of from about 1.6 to 2.0 g·cm⁻³, more preferably within the range of from about 1.1 to 1.8 g·cm⁻³. These lower densities can bring weight savings to the battery system, for example up to 5 kg or 10 kg.

It has been found that at comparatively low levels of thermally conductive nano-filler, optionally in combination with comparatively low levels of thermally conductive macro-fillers, satisfactory thermal conductivity can be achieved without at the same time leading to electrical conductivity. Thus, the curable compositions according to the invention exhibit excellent electric resistivity.

Further, it has been surprisingly found that polyol plasticizers, such as polycarbonate polyols and other polyols, are not only useful as instant fix component like other crystalizing additives, but also serve as an exfoliation aid. Exfoliation is important with respect to thermal conduction and it is principally desirable to finely disperse the thermally conductive nano-filler in a non-agglomerated state within the curable composition and the cured composition, respectively. It has now been found that polycarbonate polyols and other polyols are particularly useful to exfoliate the thermally conductive nano-filler, e.g. graphene platelets, during mixing and curing. The presence of polycarbonate polyols or other polyols may either preserve the exfoliation level of the starting material (dry graphene) thereby preventing the graphene platelets to agglomerate in the final product, or it may even increase exfoliation of the thermally conductive nano-filler, e.g. graphene platelets, compared to the starting material (dry graphene).

Still further, it has been surprisingly found that polyol plasticizers, such as polycarbonate polyols and other polyols and crystalizing additives, are useful as enhancer for improved compressibility in terms of compressive strength. Compressive strength is improved as a function of time, not only in the final cured state but also in the course of the curing process which typically lasts several minutes. While the curable composition prior to curing can be shaped and molded, the presence of polyol plasticizers, such as polycarbonate polyols and other polyols and crystalizing additives has the effect that a comparatively short period after curing has commenced, compressive strength of the curing composition is already improved and further increases in the course of ongoing curing until curing is complete.

A further advantage of the low-level filler concept in the curable composition according to the invention is to enhance durability of thermal heat transfer material. In comparison with highly filled thermal heat transfer materials, the curable composition according to the invention is less brittle, more shock resistant, and provides higher elongation, properties which are all important to battery robustness, especially when considering typical warranty periods of up to 15 years. In addition, the low-level filler concept brings benefits for lightweight concepts, improved processability due to lower abrasion, and improved curing speeds due to lower filler-caused moisture diffusion barriers. It has been surprisingly found that polyol plasticizers, such as copolymer polyols, especially SAN-grafted polyols, are useful as enhancer for improved elongation and E-modulus.

Enabling battery cell assembly and disassembly into the battery module or directly into the battery pack is a key attribute of the composition according to the invention after curing, i.e. in its cured state. Alongside desired mechanical properties, the composition according to the invention offers the desired “press-in” forces, curing speeds and preferred levels of adhesion to the battery elements and cooling plates to facilitate cell “pull-out” for replacement.

The invention offers a thermal interface material that provides sufficient rebonding to properly connect the new replacement battery element to the cooling plate, without addition of further thermal interface material. It is also contemplated to apply an activator such as water or a catalyst on the bottom of the replacement battery element, to aid the connection of the new battery element to the existing thermal interface material. The activator function may be aided by the increase in cell temperature associated with battery element charging/operation.

The curable composition according to the invention has a very low toxicity and provides primerless adhesion to a large variety of substrates including metals and thermoplastic polymers.

The properties of the curable composition according to the invention can be tailored by adding appropriate quantities of mono- or multifunctional polyols which act not only as plasticizing agents, but also as regulators to control the adhesion to the substrates such as battery cooling plates and battery casings. The mono- or multifunctional polyol plasticizer reduce the strength and help to adjust adhesion to result in low strength cure and high surface tackiness to sustain substrate contact, but allow low strength replacement and re-bonding in battery assemblies. The composition may be uncured, partially cured or cured. The key is that it provides the right physical and mechanical properties whether the composition is uncured, partially cured or cured.

Furthermore, additives can be used to specifically manipulate the morphology of the thermally conductive nano-filler and the optionally present thermally conductive macro-filler to enhance the thermal transmission throughout the material, but prevent electrical conductivity at the same time in a way that the phonon-transmission is improved, but percolation of electrically conductive fillers is reduced for very low electrical conductivity.

Compared to thermal heat transfer materials that are based upon silicones, the curable composition according to the invention has advantages with respect to the content of toxic or otherwise hazardous ingredients.

Compared to curable two-component compositions that are based e.g. upon polyurethane, the curable composition according to the invention, paired with thermally conductive nano-filler, has a 25-50% lower density. This is important, as batteries typically contain about 10 kg of thermal heat transfer material. Further, the curable composition according to the invention is more durable, especially vibration resistant and shock resistant, more stable in storage and use, non-toxic, and offers pre-treatment free adhesion to the battery substrates. Curing times can be adjusted to the individual needs.

The curable composition according to the invention performs as an adhesive with typical mechanical and physical properties of conventional silyl-modified polymer (SMP) adhesives, but with enhanced thermal conductivity in the scale needed for thermal interface products. Primarily, the curable composition according to the invention is useful in various configurations of battery systems, in order to robustly transmit heat between battery cells and adjacent cooling surfaces (for example, between the battery cells of the battery modules and the module cooling plate in a module-to-pack configuration, or between the battery cells and the pack cooling plate in a cell-to-pack configuration). The curable composition according to the invention also has utility as thermal heat transfer material in other system cooling applications.

A first aspect of the invention relates to a curable composition comprising
(i) humidity-curable prepolymer such as a humidity-curable polyurethane, silicone or polysulfone prepolymer, preferably a silyl-modified prepolymer, more preferably a silyl-modified polyether or copolyether;
(ii) thermally conductive nano-filler selected from graphene, graphene oxide, carbon nanotubes and mixtures thereof, preferably wherein the thermally conductive nano-filler has an average particle size (ASTM B330—2) of less than 1.0 μm (1000 nm);
(iii) optionally, another thermally conductive nano-filler; preferably wherein the another thermally conductive nano-filler has an average particle size (ASTM B330—2) of less than 1.0 μm (1000 nm);
(iv) optionally, thermally conductive macro-filler; preferably wherein the optionally present thermally conductive macro-filler has an average particle size (ASTM B330—2) of at least 1.0 μm (1000 nm);
(v) optionally, a curing catalyst;
(vi) optionally, a silane compatibilizer; and
(vii) optionally, a polyol plasticizer; preferably a polycarbonate polyol.

Unless expressly stated otherwise, all percentages are by weight.

Unless expressly stated otherwise, all references to standards such as ASTM, EN ISO and the like refer to the version that is officially valid on Jan. 1, 2021.

The composition according to the invention is curable, i.e. is capable of autonomously undergoing a curing reaction, typically by cross-linking, after proper stimulation, preferably by subjecting the composition to humidity. Typically, the humidity that is contained in the atmosphere is sufficient in order to stimulate, i.e. induce the curing reaction to a partial or full extent. Partial curing or curing (i.e. full curing) may be effected by reacting one or more ingredients that are contained in the composition with one another thereby forming covalent bonds.

Preferably, the curable composition according to the invention is an adhesive.

Preferably, the curable composition according to the invention is capable of partially curing or curing spontaneously at 23° C. upon contact with air humidity.

The curable composition according to the invention comprises humidity-curable prepolymer.

The composition may contain a single type of humidity-curable prepolymer or a mixture of two or more different types of humidity-curable prepolymers.

For the purpose of the specification, a prepolymer (polymer precursor) is a monomer or system of monomers that have been reacted to an intermediate molecular mass state. This material is capable of further polymerization by reactive groups to a fully cured high molecular weight state. Prepolymers encompass mixtures of reactive polymers with unreacted monomers. The prepolymer is humidity-curable, i.e. upon contact with humidity undergoes spontaneous curing, optionally also involving other ingredients that are contained in the composition such as curing agents.

Humidity-curable prepolymers are known to the skilled person and commercially available.

In preferred embodiments, the humidity-curable prepolymers according to the invention are provided in form of one-component systems, wherein preferably the entire amount of humidity for curing is air humidity after the one-component systems have been exposed to ambient air.

In other preferred embodiments, the humidity-curable prepolymers according to the invention are provided in form of two-component systems. While with regard to the two-component systems according to the invention it is principally also possible that the entire amount of humidity for curing is air humidity after the two-component systems have been exposed to ambient air, in preferred embodiments the other component of the two component systems, which does not contain the humidity-curable prepolymers, contains water such that upon mixing the two components with one another the curing reaction is initiated. The water may be present in free form or as crystal water of a suitable salt, e.g. a hydroxide phosphate and the like.

Preferably, according to this embodiment,
the first component of the two component system contains one or more humidity-curable prepolymers, preferably silyl-modified polyether prepolymer, silyl-modified polyurethane prepolymer, humidity-curable polyurethane prepolymer formulated to cure with ambient water but not being silyl-modified, or mixtures thereof; and
the second component of the two component system contains water, preferably in combination with one or more additional curing agents that are capable of reacting with the one or more humidity-curable prepolymers of the first component, optionally after these have first reacted with water. Preferred curing agents that are preferably present in addition to water, e.g. in form of solutions or emulsions, include but are not limited to
   (a) blocked amines or aldimine compounds (such as dialdimine compounds or trialdimine compounds) such as those described in WO 2007 036574 and WO 2010 112535 (both incorporated by reference). Aldimines are typically a condensation product of primary amines and aldehydes. Aldimines can be used as latent hardeners for polyurethanes, also designated “blocked amines” or “latent curing agents”;
   (b) compounds containing one or more tertiary amino groups, preferably cycloaliphatic tertiary amino groups such as those described in US 2002 0013406 or WO 2012 151085 (both incorporated by reference);
   (c) polyols such as those described in WO 2015 171307 (incorporated by reference);
   (d) epoxy resins having reactive epoxy functional groups such as those described in WO 2013 030136 (incorporated by reference), preferably liquid epoxy resins, more preferably diglycidyl ethers of bisphenol, e.g. of bisphenol A (DGEBA), of bisphenol F, or of bisphenol A/F; and
   (e) aminic silanes or aminic siloxanes such as those described in WO 2007 122261 or WO 2012 065716 (both incorporated by reference).

In preferred embodiments, the humidity-curable prepolymers according to the invention are provided as so-called boosted adhesives, i.e. booster accelerated systems preferably having open times of 30 minutes of less. The open time can be adjusted by the moisture content. Therefore, the boosted adhesives according to the invention are preferably provided in form of two-component systems with water contained in one of the two components. Preferred water contents can be in the range of from about 0.1 to 2.5 wt.-%, relative to the total weight of the curable composition.

In preferred embodiments of the curable composition according to the invention, the humidity-curable prepolymer is a silyl-modified prepolymer. As the preferred silyl-modified prepolymer is a curable prepolymer, it is a reactive prepolymer (reactive silyl-modified prepolymer). Silyl-modified prepolymers (SMP, silane-modified polymers, modified-silane polymers, MS polymers, silane-terminated polymers, etc.) are known to the skilled person and commercially available. For details on silyl-modified prepolymers, it can be referred to e.g. S. M. Guillaume, Advances in the synthesis of silyl-modified polymers (SMPs), Polym. Chem., 2018, 9, 1911-1926; A. Pizzi et al., Handbook of Adhesive Technology, CRC Press, 3rd edition, 2018. Examples of silyl-modified prepolymers include but are not limited to silyl-modified polyethers and copolyethers, silyl modified polyisobutylenes (SMPIB), silyl-modified polyacrylates and copolyacrylates (SMA) and silyl-modified polyurethanes (SPUR, PUH).

In preferred embodiments, the humidity-curable prepolymer is a polyurethane prepolymer, preferably a polyurethane homopolymer or polyurethane-urea copolymer. Preferably, the polyurethane carries terminal isocyanate groups. Humidity-curable polyurethanes are known to the skilled person. Preferably, the humidity-curable polyurethanes according to the invention are isocyanate-terminated prepolymers that are formulated to cure with ambient water.

In preferred embodiments, the cured polyurethanes (i.e. after humidity-curing) are segmented copolymer polyurethane-ureas exhibiting microphase-separated morphologies. One phase is derived from a polyol, which is preferably flexible (glass transition temperature below 23° C.) and that is generally referred to as the “soft phase”. Likewise, the corresponding “hard phase” is born from di- or polyisocyanates that through water reaction produce a highly crosslinked material with softening temperature well above 23° C.

Preferably the silyl-modified prepolymer has a non-silicone backbone, more preferably this silyl-modified prepolymer has a polyether backbone. For example, the silyl modified prepolymer can be dimethoxysilane modified polymer, trimethoxysilane modified polymer, or triethoxysilane modified polymer. For example, the silyl modified prepolymer can be a silyl-modified polyether or copolyether.

Preferred silyl-modified prepolymers according to the invention are selected from
silyl-modified polyethers or copolyethers (sometimes also referred to as “MS polymers”), preferably silyl-terminated polyethers or copolyethers, e.g. silyl-modified polyethylene glycols, silyl-modified polypropylene glycols, and the like;
silyl-modified polyurethanes (sometimes also referred to as “SPUR polymers”), preferably silyl-terminated polyurethanes; and
silyl-modified acrylates, preferably silyl-terminated acrylates.

Preferably, the silyl-modified prepolymer comprises a polymeric backbone and one or more hydrolyzable silyl groups.

Preferably, the silyl-modified prepolymer
has two ends and is terminated with one or more hydrolyzable silyl groups on one end (semitelechelic) or on both ends (telechelic); preferably on two ends; and/or
has side chains carrying one or more hydrolyzable silyl groups.

Preferably, hydrolysis of at least one of the one or more hydrolyzable silyl groups leads to the formation of a silanol group.

Preferably, the condensation of the silanol group with another silanol group or with a hydrolyzable silyl group leads to the formation of a siloxane group.

Preferably, the one or more hydrolyzable silyl groups independently of one another are
monopodal silane groups of general formula (I)

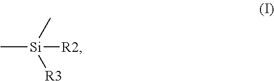

dipodal silane groups of general formula (II)

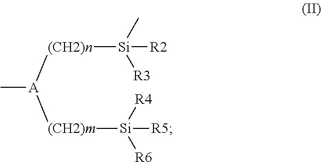

wherein in each case R1, R2, R3, R4, R5 and R6 independently of one another are selected from
substituents forming silicon-carbon bonds selected from the group consisting of —C₁₋₁₂-alkyl, —C₁₋₆-alkylene-O—C₁₋₆-alkyl, —C₆₋₁₀-aryl, —C₁₋₆-alkylene-C₆₋₁₀-aryl, —C₁₋₆-alkylene-O—C₆₋₁₀-aryl;
substituents forming silicon-oxygen bonds selected from the group consisting of —O—C₁₋₁₂-alkyl, —O—C₁₋₆-alkylene-O—C₁₋₆-alkyl, —O—C₆₋₁₀-aryl, —O—C₁₋₆-alkylene-C₆₋₁₀-aryl, —O—C₁₋₆-alkylene-O—C₆₋₁₀-aryl, —OC(═O)—C₁₋₁₂-alkyl, —OC(═O)—C₁₋₆-alkylene-O—C₁₋₆-alkyl, —OC(═O)—C₆₋₁₀-aryl, —OC(═O)—C₁₋₆-alkylene-C₆₋₁₀-aryl, —OC(═O)—C₁₋₆-alkylene-O—C₆₋₁₀-aryl;
substituents forming silicon-nitrogen bonds selected from the group consisting of —NH—C₁₋₁₂-alkyl, —NH—C₁₋₆-alkylene-O—C₁₋₆-alkyl, —NH—C₆₋₁₀-aryl, —NH—C₁₋₆-alkylene-C₆₋₁₀-aryl, —NH—C₁₋₆-alkylene-O—C₆₋₁₀-aryl;
substituents forming silicon-halogen bonds selected from the group consisting of —F, —Cl, —Br, —I;
   with the proviso that at least one of R1, R2 and R3, and at least one of R4, R5 and R6 is not a substituent forming silicon-carbon bonds; preferably with the proviso that at least one of R1, R2 and R3, and at least one of R4, R5 and R6 is selected from substituents forming silicon-oxygen bonds;
   A represents —N< or —CH<; and
   m and n independently of one another are an integer within the range of from 0 to 18, preferably 1, 2, 3 or 4.

Preferably, R1, R2, R3, R4, R5 and R6 independently of one another represent —CH₃, —CH₂CH₃, —CH₂CH₂CH₃, —CH(CH₃)₂, —CH₂CH₂CH₂CH₃, —CH(CH₃)CH₂CH₃, —CH₂CH(CH₃)₂, —C(CH₃)₃, —CH₂CH₂OCH₃, —CH₂CH₂OCH₂CH₃, —CH₂CH₂CH₂OCH₃, —CH₂CH₂CH₂OCH₂CH₃, —OCH₃, —OCH₂CH₃, —OCH₂CH₂CH₃, —OCH(CH₃)₂, —OCH₂CH₂CH₂CH₃, —OCH(CH₃)CH₂CH₃, —OCH₂CH(CH₃)₂, —OC(CH₃)₃, —OCH₂CH₂OCH₃, —OCH₂CH₂OCH₂CH₃, —OCH₂CH₂CH₂OCH₃, or —OCH₂CH₂CH₂OCH₂CH₃.

Preferably, the one or more hydrolyzable silyl groups independently of one another are selected from the group consisting of monomethoxy silane groups, monoethoxy silane groups, dimethoxy silane groups, diethoxy silane groups, trimethoxy silane groups, and triethoxy silane groups.

Preferably, the one or more hydrolyzable silyl groups are covalently bonded to the polymeric backbone through spacers, wherein the spacers independently of one another selected from —C₁₋₁₂-alkylene-, —C₃₋₈-cycloalkylene-, -phenyl-, —C₁₋₆-alkylene-phenyl-, —C₁₋₆-alkylene-phenyl-C₁₋₆-alkylene-, —C(═O)C₁₋₆-alkylene-, —S(═O)₂C₁₋₆-alkylene-, —NH—C₁₋₆-alkylene-, —NHC(═O)—C₁₋₆-alkylene-, —C(═O)NHC₁₋₆-alkylene-, —NHS(═O)₂—C₁₋₆-alkylene-, —S(═O)₂NHC₁₋₆-alkylene-, —O—C₁₋₆-alkylene-, —OC(═O)—C₁₋₆-alkylene-, —C(═O)OC₁₋₆-alkylene-, —OS(═O)₂—C₁₋₆-alkylene-, —S(═O)₂OC₁₋₆-alkylene-, —OC(═O)NH—C₁₋₆-alkylene-, —NHC(═O)O—C₁₋₆-alkylene-, —OC(═O)O—C₁₋₆-alkylene-, —NHC(═O)NH—C₁₋₆-alkylene-, —O—[Si(CH₃)₂—O]₁₋₁₂—, azasilanes, and combinations thereof.

In preferred embodiments, the silyl-modified prepolymer is
an alpha silyl prepolymer; preferably wherein the one or more hydrolyzable silyl groups are covalently bonded to the polymeric backbone through spacers, independently of one another selected from —CH₂—, —NH—CH₂—, —NHC(═O)—CH₂—, —C(═O)NH—CH₂—, —O—CH₂—, —OC(═O)—CH₂—, —C(═O)O—CH₂—, —OC(═O)NH—CH₂—, —NHC(═O)O—CH₂—, —OC(═O)O—CH₂—, and —NHC(═O)NH—CH₂—;
a beta silyl prepolymer; preferably wherein the one or more hydrolyzable silyl groups are covalently bonded to the polymeric backbone through spacers, independently of one another selected from —CH₂CH₂—, —NH—CH₂CH₂—, —NHC(═O)—CH₂CH₂—, —C(═O)NH—CH₂CH₂—, —O—CH₂CH₂—, —OC(═O)CH₂CH₂—, —C(═O)O—CH₂CH₂—, —OC(═O)NH—CH₂CH₂—, —NHC(═O)O—CH₂CH₂—, —OC(═O)OCH₂CH₂—, and —NHC(═O)NH—CH₂CH₂—;
a gamma silyl prepolymer; preferably wherein the one or more hydrolyzable silyl groups are covalently bonded to the polymeric backbone through spacers, independently of one another selected from —CH₂CH₂CH₂—, —NH—CH₂CH₂CH₂—, —NHC(═O)—CH₂CH₂CH₂—, —C(═O)NH—CH₂CH₂CH₂—, —O—CH₂CH₂CH₂—, —OC(═O)—CH₂CH₂CH₂—, —C(═O)O—CH₂CH₂CH₂—, —OC(═O)NH—CH₂CH₂CH₂—, —NHC(═O)O—CH₂CH₂CH₂—, —OC(═O)O—CH₂CH₂CH₂—, and —NHC(═O)NH—CH₂CH₂CH₂—; or
a delta silyl prepolymer; preferably wherein the one or more hydrolyzable silyl groups are covalently bonded to the polymeric backbone through spacers, independently of one another selected from —CH₂CH₂CH₂CH₂—, —NH—CH₂CH₂CH₂CH₂—, —NHC(═O)—CH₂CH₂CH₂CH₂—, —C(═O)NHCH₂CH₂CH₂CH₂—, —O—CH₂CH₂CH₂CH₂—, —OC(═O)—CH₂CH₂CH₂CH₂—, —C(═O)O—CH₂CH₂CH₂CH₂—, —OC(═O)NH—CH₂CH₂CH₂CH₂—, —NHC(═O)O—CH₂CH₂CH₂CH₂—, —OC(═O)O—CH₂CH₂CH₂CH₂—, and —NHC(═O)NH—CH₂CH₂CH₂CH₂—.

Preferably, the humidity-curable prepolymer comprises a polymeric backbone selected from the group consisting of
polyethers, copolyethers;
polyurethanes, copolyurethanes;
polysilicones, copolysilicones;
polysulfones, copolysulfones;
polyesters, copolyesters;
polyamides, copolyamids;
polyolefins, copolyolefins;
polystyrenes, copolystyrenes;
polyacrylates, copolyacrylates,
   and mixtures thereof, preferably polyethers or copolyethers.

For the purpose of the specification,
ether repetition units are preferably —O—R— or —O—R—O—R′—;
urethane repetition units are preferably —O—R—NH—C(═O)— or —O—R—O—C(═O)—NH—R′—NH—C(═O)—;
siloxane repetition units are preferably —Si(C₁₋₆-alkyl)₂-O— or —Si(C₁₋₆-alkyl)₂-O—Si(C₁₋₆-alkyl)₂-O—;
sulfone repetition units are preferably —S(═O)₂—R— or —S(═O)₂—R—S(═O)₂—R′—;
ester repetition units are preferably —O—R—C(═O)— or —O—R—O—C(═O)—R′—C(═O)—;
amide repetition units are preferably —NH—R—C(═O)— or —NH—R—NH—C(═O)—R′—C(═O)—;
carbonate repetition units are preferably —O—C(═O)—O—R— or —O—C(═O)—O—R—O—C(═O)—O—R′—;
urea repetition units are preferably —NH—C(═O)—NH—R— or —NH—C(═O)—NH—R—NH—C(═O)—NH—R′—;
alkyl repetition units are preferably —R— or —R—R′—;
   wherein in each case R and R′ independently of one another preferably mean —C₁₋₁₂-alkyl-, -aryl-, —C₁₋₆-alkyl-aryl-, -aryl-C₁₋₆-alkyl-, or —C₁₋₆-alkyl-aryl-C₁₋₆-alkyl-; wherein alkyl can be linear or branched and wherein aryl preferably means phenyl which may optionally be substituted with 1, 2, 3 or 4 substituents independently of one another selected from —F, —Cl, —CN, —C₁₋₆-alkyl, and —O—C₁₋₆-alkyl.

In preferred embodiments, the polymeric backbone is
a linear or branched, aliphatic and/or aromatic polyether or copolyether comprising ether repetition units (e.g. —O—R— or —O—R—O—R′—); or
a linear or branched, aliphatic and/or aromatic copolyether comprising ether repetition units and comonomer repetition units; preferably wherein the comonomer repetition units are selected from urethane repetition units, siloxane repetition units, sulfone repetition units, ester repetition units, amide repetition units, carbonate repetition units, urea repetition units, alkyl repetition units, and mixtures thereof.

Preferably, the humidity-curable prepolymer is selected from the group consisting of dimethoxy-silyl-terminated polyether or copolyether, trimethoxy-silyl-terminated polyether or copolyether, dimethoxy-silyl-terminated polyether or copolyether in each case reinforced with silicone moieties, trimethoxy-silyl-terminated polyether or copolyether in each case reinforced with silicone moieties, hydrophobically modified dimethoxy-silyl-terminated polyether or copolyether, monofunctional dimethoxy-silyl-terminated polyether or copolyether, and monofunctional trimethoxy-silyl-terminated polyether or copolyether.

The silyl-modified polyether or copolyether can be obtained by reacting a polyether or copolyether with at least one ethylenically unsaturated silane in the presence of a radical starter, the ethylenically unsaturated silane carrying at least one hydrolyzable group on the silicon atom. The ethylenically unsaturated silane is particularly preferably selected from the group consisting of vinyltrimethoxysilane, vinyltriethoxysilane, vinyldimethoxymethylsilane, vinyldiethoxymethylsilane, trans-p-methylacrylic acid trimethoxysilylmethyl ester, and trans-b-methylacrylic acid trimethoxysilylpropyl ester.

Silyl-modified prepolymers such as silyl-modified polyether and copolyether are available, for example, as dimethoxysilane modified MS polymer from Kaneka, trimethoxysilane modified ST polymer from Evonik, triethoxysilane modified Tegopac polymer from Evonik, silane modified Desmoseal polymer from Covestro, or silane modified SMP polymer from Henkel.

In preferred embodiments, the polymeric backbone is
a linear or branched, aliphatic and/or aromatic polyurethane or copolyurethane comprising urethane repetition units (e.g. —O—R—NH—C(═O)— or —O—R—O—C(═O)—NH—R′—NH—C(═O)—); or
a linear or branched, aliphatic and/or aromatic copolyurethane comprising urethane repetition units and comonomer repetition units; preferably wherein the comonomer repetition units are selected from ether repetition, siloxane repetition units, sulfone repetition units, ester repetition units, amide repetition units, carbonate repetition units, urea repetition units, alkyl repetition units, and mixtures thereof.

Preferably, the humidity-curable prepolymer is selected from the group consisting of dimethoxy-silyl-terminated polyurethane or copolyurethane, trimethoxy-silyl-terminated polyurethane or copolyurethane, dimethoxy-silyl-terminated polyurethane or copolyurethane in each case reinforced with silicone moieties, trimethoxy-silyl-terminated polyurethane or copolyurethane in each case reinforced with silicone moieties, hydrophobically modified dimethoxy-silyl-terminated polyurethane or copolyurethane, monofunctional dimethoxy-silyl-terminated polyurethane or copolyurethane, and monofunctional trimethoxy-silyl-terminated polyurethane or copolyurethane.

The silyl-modified polyurethane or copolyurethane can be obtained by reacting a hydroxyl-terminated polyurethane or copolyurethane with at least one ethylenically unsaturated silane in the presence of a radical starter, the ethylenically unsaturated silane carrying at least one hydrolyzable group on the silicon atom. The ethylenically unsaturated silane is particularly preferably selected from the group consisting of vinyltrimethoxysilane, vinyltriethoxysilane, vinyldimethoxymethylsilane, vinyldiethoxymethylsilane, trans-p-methylacrylic acid trimethoxysilylmethyl ester, and trans-b-methylacrylic acid trimethoxysilylpropyl ester.

In preferred embodiments, the polymeric backbone is
a linear or branched, aliphatic and/or aromatic polysilicone or copolysilicone (siloxane or copolysiloxane) comprising siloxane repetition units (e.g. —Si(C₁₋₆-alkyl)₂-O— or —SiR₂—O—Si(C₁₋₆-alkyl)₂-O—); or
a linear or branched, aliphatic and/or aromatic copolysilicone comprising siloxane repetition units and comonomer repetition units; preferably wherein the comonomer repetition units are selected from ether repetition, urethane repetition units, sulfone repetition units, ester repetition units, amide repetition units, carbonate repetition units, urea repetition units, alkyl repetition units, and mixtures thereof.

Preferably, the humidity-curable prepolymer is selected from the group consisting of dimethoxy-silyl-terminated polysilicone or copolysilicone, trimethoxy-silyl-terminated polysilicone or copolysilicone, hydrophobically modified dimethoxy-silyl-terminated polysilicone or copolysilicone, monofunctional dimethoxy-silyl-terminated polysilicone or copolysilicone, and monofunctional trimethoxy-silyl-terminated polysilicone or copolysilicone.

The silyl-modified polysilicone or copolysilicone can be obtained by reacting a hydroxyl-terminated polysilicone or copolysilicone with at least one ethylenically unsaturated silane in the presence of a radical starter, the ethylenically unsaturated silane carrying at least one hydrolyzable group on the silicon atom. The ethylenically unsaturated silane is particularly preferably selected from the group consisting of vinyltrimethoxysilane, vinyltriethoxysilane, vinyldimethoxymethylsilane, vinyldiethoxymethylsilane, trans-p-methylacrylic acid trimethoxysilylmethyl ester, and trans-b-methylacrylic acid trimethoxysilylpropyl ester.

In preferred embodiments, the polymeric backbone is
a linear or branched, aliphatic and/or aromatic polysulfone or copolysulfone comprising sulfone repetition units (e.g. —S(═O)₂—R— or —S(═O)₂—R—S(═O)₂—R′—); or
a linear or branched, aliphatic and/or aromatic copolysulfone comprising sulfone repetition units and comonomer repetition units; preferably wherein the comonomer repetition units are selected from ether repetition, urethane repetition units, siloxane repetition units, ester repetition units, amide repetition units, carbonate repetition units, urea repetition units, alkyl repetition units, and mixtures thereof.

Preferably, the humidity-curable prepolymer is selected from the group consisting of dimethoxy-silyl-terminated polysulfone or copolysulfone, trimethoxy-silyl-terminated polysulfone or copolysulfone, dimethoxy-silyl-terminated polysulfone or copolysulfone in each case reinforced with silicone moieties, trimethoxy-silyl-terminated polysulfone or copolysulfone in each case reinforced with silicone moieties, hydrophobically modified dimethoxy-silyl-terminated polysulfone or copolysulfone, monofunctional dimethoxy-silyl-terminated polysulfone or copolysulfone, and monofunctional trimethoxy-silyl-terminated polysulfone or copolysulfone.

The silyl-modified polysulfone or copolysulfone can be obtained by reacting a hydroxyl-terminated polysulfone or copolysulfone with at least one ethylenically unsaturated silane in the presence of a radical starter, the ethylenically unsaturated silane carrying at least one hydrolyzable group on the silicon atom. The ethylenically unsaturated silane is particularly preferably selected from the group consisting of vinyltrimethoxysilane, vinyltriethoxysilane, vinyldimethoxymethylsilane, vinyldiethoxymethylsilane, trans-p-methylacrylic acid trimethoxysilylmethyl ester, and trans-b-methylacrylic acid trimethoxysilylpropyl ester.

Preferably, the humidity-curable prepolymer has a weight average molecular weight (ASTM D5296-19) within the range of from about 500 to 50,000 g/mol, preferably about 1000 to 25,000 g/mol.

Preferably, the humidity-curable prepolymer has a Brookfield viscosity at 23° C. (ASTM D789, D4878) within the range of from about 100 to 35,000 mPa s, preferably about 500 to 35,000 mPa s.

Preferably, the weight content of the humidity-curable prepolymer is
at least about 10 wt.-%, preferably at least about 20 wt.-%, more preferably at least about 30 wt.-%, still more preferably at least about 35 wt.-%; and/or
at most about 90 wt.-%, preferably at most about 80 wt.-%, more preferably at most about 70 wt.-%, still more preferably at most about 55 wt.-%; and/or
within the range of from about 10 to 90% wt.-%, preferably from about 20 to 80 wt.-%, more preferably from about 30 to 70 wt.-%, still more preferably from about 35 to 55 wt.-%;
in each case relative to the total weight of the curable composition.

The curable composition according to the invention comprises thermally conductive nano-filler selected from graphene, graphene oxide, carbon nanotubes and mixtures thereof. For the purpose of the specification, a thermally conductive nano-filler has a particle size in the nanometer scale, i.e. typically less than 1.0 μm. Particles of graphene, graphene oxide or carbon tubes that have particle sizes in the nanometer scale are known to the skilled person and commercially available.

Graphene according to the invention encompasses an allotrope of carbon, whose structure is one-atom-thick planar sheets of sp²-bonded carbon atoms that are densely packed in a honeycomb crystal lattice. Furthermore, graphene according to the invention encompasses graphene nanoplatelets, graphene nanoribbons and graphene nano-onions.

Preferably, the thermally conductive nano-filler has a thermal conductivity at 23° C. (ASTM E1530) of at least about 2000 W·m⁻¹·K⁻¹, preferably at least about 2500 W·m⁻¹K⁻¹, more preferably at least about 3000 W·m⁻¹·K⁻¹, still more preferably at least about 3500 W·m⁻¹·K⁻¹, yet more preferably at least about 4000 W·m⁻¹·K⁻¹.

Preferably, the thermally conductive nano-filler has density (ASTM D792—20) of about 2.2±0.2 g·cm⁻³, preferably about 2.2±0.2 g·cm⁻³.

Preferably, the thermally conductive nano-filler has a bulk density (EN ISO 60) of at most about 350 kg·m⁻³, preferably at most about 300 kg·m⁻³, more preferably at most about 250 kg·m⁻³, still more preferably at most about 200 kg·m⁻³, yet more preferably at most about 175 kg·m⁻³, even more preferably at most about 150 kg·m⁻³, most preferably at most about 125 kg·m⁻³, and in particular at most about 110 kg·m⁻³.

Preferably, the thermally conductive nano-filler has an average particle size (ASTM B330—2) of less than 1.0 μm (1000 nm).

Preferably, the thermally conductive nano-filler has an average particle size (ASTM B330—2) in the range of from about 1 nm to 900 nm; preferably within the range of about 10±5 nm, or 15 10 nm, or 20±15 nm, or 25±20 nm, or 50±40 nm, or 75±60 nm, or 100±75 nm, or 150±125 nm, or 200±150 nm, or 250±200 nm, or 300±250 nm, or 350±300 nm, or 400±350 nm, or 450±400 nm, or 500±450 nm.

Preferably, the thermally conductive nano-filler has a volume median diameter d50, determined by laser diffraction in accordance with ISO 13320:2020-01 and/or ASTM B822-20, within the range of from about 1.0 to 100 μm, preferably about 5.0 to 80 μm, more preferably about 10 to 70 μm, still more preferably about 15 to 65 μm, yet more preferably about 20 to 60 μm, even more preferably about 25 to 55 μm, most preferably about 30 to 50 μm, and in particular about 35 to 45 μm.

Preferably, the thermally conductive nano-filler has a surface area (ASTM B922—20) of at least about 2000 m²·g⁻¹, preferably at least about 2200 m²·g⁻¹.

Preferably, the thermally conductive nano-filler has a surface area (ASTM B922—20) of at least about 100 m²·g⁻¹, preferably at least about 150 m²·g⁻¹, more preferably at least about 200 m²·g⁻¹, still more preferably at least about 225 m²·g⁻¹, yet more preferably at least about 250 m²·g⁻¹, even more preferably at least about 260 m²·g⁻¹, most preferably at least about 270 m²·g⁻¹, and in particular at least about 280 m²·g⁻¹.

Preferably, the thermally conductive nano-filler has an average thickness, determined by scanning electron microscopy (SEM) in accordance with ASTM E3220-20, within the range of from about 0.4 to 40 nm, preferably about 0.6 to 30 nm, more preferably about 0.8 to 25 nm, still more preferably about 1.0 to 20 nm, yet more preferably about 2.0 to 18 nm, even more preferably about 4.0 to 16 nm, most preferably about 6.0 to 14 nm, and in particular about 8.0 to 12 nm.

Preferably, the thermally conductive nano-filler has a number of layers, determined by scanning electron microscopy (SEM) in accordance with ASTM E3220-20, of at most about 100, preferably at most about 80, more preferably at most about 60, still more preferably at most about 50, yet more preferably at most about 45, even more preferably at most about 40, most preferably at most about 35, and in particular at most about 30.

Preferably, the thermally conductive nano-filler has a carbon content, determined by x-ray photoelectron spectroscopy (XPS) in accordance with ASTM E3220-20, of at least about 80%, more preferably at least about 85%, still more preferably at least about 90%, yet more preferably at least about 95%, even more preferably at least about 96%, most preferably at least about 97%, and in particular at least about 98%.

Preferably, the thermally conductive nano-filler has an oxygen content, determined by x-ray photoelectron spectroscopy (XPS) in accordance with ASTM E3220-20, of at most about 5.0%, more preferably at most about 4.0%, still more preferably at most about 3.0%, yet more preferably at most about 2.5%, even more preferably at most about 2.0%, most preferably at most about 1.5%, and in particular at most about 1.0%.

Preferably, the weight content of thermally conductive nano-filler is
at least about 0.1 wt.-%, preferably at least about 0.5 wt.-%, more preferably at least about 1.0 wt.-%, still more preferably at least about 2.5 wt.-%; and/or
at most about 10 wt.-%, preferably at most about 7.5 wt.-%, more preferably at most about 6.0 wt.-%, still more preferably at most about 5.0 wt.-%;
within the range of from about 0.1 to 10 wt.-%, preferably from about 0.5 to 7.5 wt.-%, more preferably from about 1.0 to 6.0 wt.-%, still more preferably from about 2.5 to 5.0 wt.-%, yet more preferably within the rage of about 1.0±0.5 wt.-%, or 1.5±1.0 wt.-%, or 2.0±1.5 wt.-%, or 2.5±2.0 wt.-%, or 3.0±2.5 wt.-%, or 3.5±3.0 wt.-%, or 4.0±3.5 wt.-%, or 4.5±4.0 wt.-%, or 5.0±4.5 wt.-%;
   in each case relative to the total weight of the curable composition and the total weight of the thermally conductive nano-filler.

Preferably, the weight content of thermally conductive nano-filler is
at least about 4.0 wt.-%, preferably at least about 6.0 wt.-%, more preferably at least about 8.0 wt.-%, still more preferably at least about 10 wt.-%; and/or
at most about 30 wt.-%, preferably at most about 25 wt.-%, more preferably at most about 20 wt.-%, still more preferably at most about 15 wt.-%;
within the range of from about 4.0 to 30 wt.-%, preferably from about 6.0 to 25 wt.-%, more preferably from about 8.0 to 20 wt.-%, still more preferably from about 10 to 15 wt.-%, yet more preferably within the rage of about 7.5±2.5 wt.-%, or 10±5.0 wt.-%, or 10±2.5 wt.-%, or 12.5±7.5 wt.-%, or 12.5±5.0 wt.-%, or 12.5±2.5 wt.-%, or 15±10 wt.-%, or 15±7.5 wt.-%, or 15±5.0 wt.-%, or 15±2.5 wt.-%;
   in each case relative to the total weight of the curable composition and the total weight of the thermally conductive nano-filler.

Preferably, the curable composition according to the invention comprises graphene but essentially no graphene oxide.

The curable composition according to the invention optionally comprises another thermally conductive nano-filler. For the purpose of the specification, another thermally conductive nano-filler is a solid material having a particle size in the nanometer scale, preferably less than 1.0 μm, that may contribute to the thermal conductivity of the composition. Suitable nano-fillers are known to the skilled person and commercially available.

In preferred embodiments, the another thermally conductive nano-filler is
a nitride, preferably a covalent nitride, more preferably selected from the group consisting of boron nitride (BN), aluminum nitride (AlN), gallium nitride (GaN), indium nitride (InN), carbon nitride (C₃N₄), silicon nitride (Si₃N₄), germanium nitride (Ge₃N₄), tin nitride (Sn₃N₄), phosphorous nitride (P₃N₅), and copper nitride (Cu₃N);
an oxide, preferably selected from the group consisting of aluminum oxide (Al₂O₃), zinc oxide (ZnO), beryllium oxide (BeO), calcium oxide (CaO), magnesium oxide (MgO), iron oxide (Fe₂O₃), and silicon oxide (SiO₂);
a carbide, preferably selected from silicon carbide (SiC), titanium carbide (TiC), and tungsten carbide (WC);
a hydroxide, preferably selected from the group consisting of aluminum trihydrate (Al(OH)₃), magnesium hydroxide (Mg(OH)₂);
a carbonate, preferably selected from the group consisting of magnesium carbonate (MgCO₃), calcium carbonate (CaCO₃), strontium carbonate (SrCO₃), and barium carbonate (BaCO₃);
graphite;
or a mixture of any of the foregoing;
   preferably calcium carbonate.

Preferably, graphite according to the invention does not encompass an allotrope of carbon, whose structure is one-atom-thick planar sheets of sp²-bonded carbon atoms that are densely packed in a honeycomb crystal lattice; graphene nanoplatelets, graphene nanoribbons and graphene nano-onions.

Preferably, the another thermally conductive nano-filler has a thermal conductivity at 23° C. (ASTM E1530) of
at least about 2.0 W·m⁻¹·K⁻¹, preferably at least about 4.0 W·m⁻¹·K⁻¹, more preferably at least about 6.0 W·m⁻¹K⁻¹, still more preferably at least about 8.0 W·m⁻¹·K⁻¹, yet more preferably at least about 10 W·m⁻¹·K⁻¹, even more preferably at least about 15 W·m⁻¹·K⁻¹, most preferably at least about 20 W·m⁻¹·K⁻¹, and in particular at least about 25 W·m⁻¹·K⁻¹; and/or
at most about 1500 W·m⁻¹·K⁻¹, preferably at most about 1000 W·m⁻¹·K⁻¹, more preferably at most about 800 W·m⁻¹·K⁻¹, still more preferably at most about 600 W m⁻¹·K⁻¹, yet more preferably at most about 400 W·m⁻¹·K⁻¹, even more preferably at most about 200 W·m⁻¹·K⁻¹, most preferably at most about 150 W·m⁻¹·K⁻¹, and in particular at most about 100 W·m⁻¹·K⁻¹.

Preferably, the another thermally conductive nano-filler has an average particle size (ASTM B330—2) of less than 1.0 μm (1000 nm).

Preferably, the another thermally conductive nano-filler has an average particle size (ASTM B330—2) in the range of from about 1 nm to 900 nm; preferably within the range of about 10±5 nm, or 15±10 nm, or 20±15 nm, or 25±20 nm, or 50±40 nm, or 75±60 nm, or 100±75 nm, or 150±125 nm, or 200±150 nm, or 250±200 nm, or 300±250 nm, or 350±300 nm, or 400±350 nm, or 450±400 nm, or 500±450 nm; more preferably within the range of from about 10 to 80 nm.

In preferred embodiments, the another thermally conductive nano-filler has a multimodal, e.g. bimodal particle size distribution, and may result e.g. from a mixture of two or more another thermally conductive nano-fillers having a different average particle size. Said two or more another thermally conductive nano-fillers may be of the same or a different material. Preferably, the relative difference of the average particle size (ASTM B330—2) of two another thermally conductive nano-fillers in said mixture is at least about 10 nm, or at least about 25 nm, or at least about 50 nm, or at least about 75 nm, or at least about 100 nm. These embodiments account for placing a higher number of different sized particles into a space unit, because when the space is packed with large size particles, small size particle can still be placed in the gaps between.

The thermally conductive nano-filler as well as the another thermally conductive nano-filler do not only serve the purpose of enhancing thermal conductivity of the curable composition, where increasing the amount of filler would typically further increase thermal conductivity (and density). On the contrary, it is also an important property of the curable composition according to the invention that percolation of electrically conductive fillers is prevented by efficiently placing electrically nonconductive material in between, i.e. by keeping electrically conductive filler particles spatially apart from one another. Thus, as far as the total amount of thermally conductive nano-filler as well as the another thermally conductive nano-filler is concerned, a balance is to be found not only with respect to low density.

Said balance is reflected by a certain upper limit of the total amount of thermally conductive nano-filler as well as the another thermally conductive nano-filler that ensures dispersion of filler material as a discontinuous phase within the remainder of the curable composition serving as a continuous phase. In consequence, the curable composition has a good thermal conductivity, a good electric resistivity, and a low density.

Preferably, the weight content of the another thermally conductive nano-filler is
at least about 10 wt.-%, preferably at least about 15 wt.-%, more preferably at least about 20 wt.-%, still more preferably at least about 25 wt.-%; and/or
at most about 45 wt.-%, preferably at most about 40 wt.-%, more preferably at most about 35 wt.-%, still more preferably at most about 30 wt.-%; and/or
within the range of from about 10 to 45 wt.-%, preferably from about 20 to 35 wt.-%, more preferably within the range of about 20±2.0 wt.-%, or 22±4.0 wt.-%, or 22±2.0 wt.-%, or 24±6.0 wt.-%, or 24±4.0 wt.-%, or 24±2.0 wt.-%, or 26±8.0 wt.-%, or 26±6.0 wt.-%, or 26±4.0 wt.-%, or 26±2.0 wt.-%, or 28±10 wt.-%, or 28±8.0 wt.-%, or 28±6.0 wt.-%, or 28±4.0 wt.-%, or 28±2.0 wt.-%, or 30±12 wt.-%, or 30±10 wt.-%, or 30±8.0 wt.-%, or 30±6.0 wt.-%, or 30±4.0 wt.-%, or 30±2.0 wt.-%; in each case relative to the total weight of the curable composition and the total weight of the another thermally conductive nano-filler.

In preferred embodiments, the total weight content of the thermally conductive nano-filler and the another thermally conductive nano-filler is
at least about 15 wt.-%, preferably at least about 20 wt.-%, more preferably at least about 25 wt.-%, still more preferably at least about 30 wt.-%; and/or
at most about 55 wt.-%, preferably at most about 50 wt.-%, more preferably at most about 45 wt.-%, still more preferably at most about 40 wt.-%; and/or
within the range of from about 15 to 55 wt.-%, preferably from about 25 to 45 wt.-%, more preferably within the range of about 26±2.0 wt.-%, or 28±4.0 wt.-%, or 28±2.0 wt.-%, or 30±6.0 wt.-%, or 30±4.0 wt.-%, or 30±2.0 wt.-%, or 32±8.0 wt.-%, or 32±6.0 wt.-%, or 32±4.0 wt.-%, or 32±2.0 wt.-%, or 34±10 wt.-%, or 34±8.0 wt.-%, or 34±6.0 wt.-%, or 34±4.0 wt.-%, or 34±2.0 wt.-%, or 36±12 wt.-%, or 36±10 wt.-%, or 36±8.0 wt.-%, or 36±6.0 wt.-%, or 36±4.0 wt.-%, or 36±2.0 wt.-%; in each case relative to the total weight of the curable composition, the total weight of the thermally conductive nano-filler and the total weight of the another thermally conductive nano-filler.

The curable composition according to the invention optionally comprises thermally conductive macro-filler. For the purpose of the specification, a thermally conductive macro-filler is any solid material having a particle size greater than the nanometer scale, preferably at least 1.0 μm, that may contribute to the thermal conductivity of the composition. Suitable macro-fillers are known to the skilled person and commercially available.

In preferred embodiments, the thermally conductive macro-filler is
a nitride, preferably a covalent nitride, more preferably selected from the group consisting of boron nitride (BN), aluminum nitride (AlN), gallium nitride (GaN), indium nitride (InN), carbon nitride (C₃N₄), silicon nitride (Si₃N₄), germanium nitride (Ge₃N₄), tin nitride (Sn₃N₄), phosphorous nitride (P₃N₅), and copper nitride (Cu₃N);
an oxide, preferably selected from the group consisting of aluminum oxide (Al₂O₃), zinc oxide (ZnO), beryllium oxide (BeO), calcium oxide (CaO), magnesium oxide (MgO), iron oxide (Fe₂O₃), and silicon oxide (SiO₂);
a carbide, preferably selected from silicon carbide (SiC), titanium carbide (TiC), and tungsten carbide (WC);
a hydroxide, preferably selected from the group consisting of aluminum trihydrate (Al(OH)₃), magnesium hydroxide (Mg(OH)₂);
a carbonate, preferably selected from the group consisting of magnesium carbonate (MgCO₃), calcium carbonate (CaCO₃), strontium carbonate (SrCO₃), and barium carbonate (BaCO₃);
graphite;
or a mixture of any of the foregoing;
preferably calcium carbonate.

Preferably, the thermally conductive macro-filler has a thermal conductivity at 23° C. (ASTM E1530) of
at least about 2.0 W·m⁻¹·K⁻¹, preferably at least about 4.0 W·m⁻¹·K⁻¹, more preferably at least about 6.0 W·m⁻¹·K⁻¹, still more preferably at least about 8.0 W·m⁻¹K⁻¹, yet more preferably at least about 10 W·m⁻¹·K⁻¹, even more preferably at least about 15 W·m⁻¹·K⁻¹, most preferably at least about 20 W·m⁻¹·K⁻¹, and in particular at least about 25 W·m⁻¹·K⁻¹; and/or
at most about 1500 W·m⁻¹·K⁻¹, preferably at most about 1000 W·m⁻¹·K⁻¹, more preferably at most about 800 W·m⁻¹·K⁻¹, still more preferably at most about 600 W·m⁻¹·K⁻¹, yet more preferably at most about 400 W·m⁻¹·K⁻¹, even more preferably at most about 200 W·m⁻¹·K⁻¹, most preferably at most about 150 W·m⁻¹·K⁻¹, and in particular at most about 100 W·m⁻¹·K⁻¹.

Preferably, the thermally conductive macro-filler has an average particle size (ASTM B330—2) of at least 1.0 μm (1000 nm).

Preferably, the thermally conductive macro-filler has an average particle size (ASTM B330—2) in the range of from about 2.5±2.0 μm, or 2.5±1.5 μm, or 5.0±4.5 μm, or 5.0±4.0 μm, or 7.5±7.0 μm, or 7.5±6.5 μm, or 10±9.0 μm, or 25±20 μm, or 50±45 μm, or 75±65 μm, or 100±90 μm, or 200±190 μm, or 300±290 μm, or 400±390 μm, or 500±490 μm.

In preferred embodiments, the thermally conductive macro-filler has a multimodal, e.g. bimodal particle size distribution, and may result e.g. from a mixture of two or more thermally conductive macrofillers having a different average particle size. Said two or more thermally conductive macro-fillers may be of the same or a different material. Preferably, the relative difference of the average particle size (ASTM B330—2) of two thermally conductive macro-fillers in said mixture is at least about 10 μm, or at least about 25 μm, or at least about 50 μm, or at least about 75 μm, or at least about 100 μm. These embodiments account for placing a higher number of different sized particles into a space unit, because when the space is packed with large size particles, small size particle can still be placed in the gaps between.

The thermally conductive nano-filler as well as the thermally conductive macro-filler do not only serve the purpose of enhancing thermal conductivity of the curable composition, where increasing the amount of filler would typically further increase thermal conductivity (and density). On the contrary, it is also an important property of the curable composition according to the invention that percolation of electrically conductive fillers is prevented by efficiently placing electrically nonconductive material in between, i.e. by keeping electrically conductive filler particles spatially apart from one another. Thus, as far as the total amount of thermally conductive nano-filler as well as the thermally conductive macrofiller is concerned, a balance is to be found not only with respect to low density. Said balance is reflected by a certain upper limit of the total amount of thermally conductive nano-filler as well as the thermally conductive macro-filler that ensures dispersion of filler material as a discontinuous phase within the remainder of the curable composition serving as a continuous phase. In consequence, the curable composition has a good thermal conductivity, a good electric resistivity, and a low density.

Preferably, the weight content of the thermally conductive macro-filler is
at least about 0.5 wt.-%, preferably at least about 1.0 wt.-%, more preferably at least about 1.5 wt.-%, still more preferably at least about 2.0 wt.-%; and/or
at most about 20 wt.-%, preferably at most about 15 wt.-%, more preferably at most about 12.5 wt.-%, still more preferably at most about 10 wt.-%;
within the range of from about 0.5 to 20 wt.-%, preferably from about 10 to 15 wt.-%, more preferably within the range of about 1.0±0.5 wt.-%, or 1.5±1.0 wt.-%, or 2.0±1.5 wt.-%, or 2.5±2.0 wt.-%, or 3.0±2.5 wt.-%, or 3.5±3.0 wt.-%, or 4.0±3.5 wt.-%, or 4.5±4.0 wt.-%, or 5.0±4.5 wt.-%, or 5.5±5.0 wt.-%, or 6.0±5.5 wt.-%, or 6.5±6.0 wt.-%, or 7.0±6.5 wt.-%, or 7.5±7.0 wt.-%, or 8.0±7.5 wt.-%, or 8.5±8.0 wt.-%, or 9.0±8.5 wt.-%, or 9.5±9.0 wt.-%, or 10±9.5 wt.-%;
   in each case relative to the total weight of the curable composition and the total weight of the thermally conductive macro-filler.

Preferably, the weight content of the thermally conductive macro-filler is
at least about 6.0 wt.-%, preferably at least about 8.0 wt.-%, more preferably at least about 10 wt.-%, still more preferably at least about 12 wt.-%; and/or
at most about 40 wt.-%, preferably at most about 30 wt.-%, more preferably at most about 25 wt.-%, still more preferably at most about 20 wt.-%;
within the range of from about 8.0 to 40 wt.-%, preferably from about 12 to 30 wt.-%, more preferably within the range of about 11 1.0 wt.-%, or 13±2.0 wt.-%, or 13±1.0 wt.-%, or 15±3.0 wt.-%, or 15±2.0 wt.-%, or 15±1.0 wt.-%, or 17±4.0 wt.-%, or 17±3.0 wt.-%, or 17±2.0 wt.-%, or 17±1.0 wt.-%, or 19±5.0 wt.-%, or 19±4.0 wt.-%, or 19±3.0 wt.-%, or 19±2.0 wt.-%, or 19±1.0 wt.-%, or 20±6.0 wt.-%, or 20±5.0 wt.-%, or 20±4.0 wt.-%, or 20±3.0 wt.-%;
   in each case relative to the total weight of the curable composition and the total weight of the thermally conductive macro-filler.

In preferred embodiments, the total weight content of the thermally conductive nano-filler and the thermally conductive macro-filler is
at least about 2.5 wt.-%, preferably at least about 5.0 wt.-%, more preferably at least about 7.5 wt.-%, still more preferably at least about 10 wt.-%; and/or
at most about 30 wt.-%, preferably at most about 25 wt.-%, more preferably at most about 20 wt.-%, still more preferably at most about 15 wt.-%;
within the range of from about 2.5 to 30 wt.-%, preferably from about 5.0 to 25 wt.-%, more preferably within the range of about 1.0±0.5 wt.-%, or 1.5±1.0 wt.-%, or 2.0±1.5 wt.-%, or 2.5±2.0 wt.-%, or 3.0±2.5 wt.-%, or 3.5±3.0 wt.-%, or 4.0±3.5 wt.-%, or 4.5±4.0 wt.-%, or 5.0±4.5 wt.-%, or 5.5±5.0 wt.-%, or 6.0±5.5 wt.-%, or 6.5±6.0 wt.-%, or 7.0±6.5 wt.-%, or 7.5±7.0 wt.-%, or 8.0±7.5 wt.-%, or 8.5±8.0 wt.-%, or 9.0±8.5 wt.-%, or 9.5±9.0 wt.-%, or 10±9.5 wt.-%, or 11±10 wt.-%, or 12±11 wt.-%, or 13±12 wt.-%, or 14±13 wt.-%, or 15±14 wt.-%;
   in each case relative to the total weight of the curable composition, the total weight of the thermally conductive nano-filler and the total weight of the thermally conductive macro-filler.

In preferred embodiments, the total weight content of the thermally conductive nano-filler and the thermally conductive macro-filler is
at least about 4.0 wt.-%, preferably at least about 8.0 wt.-%, more preferably at least about 12 wt.-% still more preferably at least about 16 wt.-%; and/or
at most about 40 wt.-%, preferably at most about 35 wt.-%, more preferably at most about 30 wt.-%, still more preferably at most about 25 wt.-%;
within the range of from about 4.0 to 40 wt.-%, preferably from about 12 to 30 wt.-%, more preferably within the range of about 12±2.5 wt.-%, or 15±5.0 wt.-%, or 15±2.5 wt.-%, or 18±7.5 wt.-%, or 18±5.0 wt.-%, or 18±2.5 wt.-%, or 21±10 wt.-%, or 21±7.5 wt.-%, or 21±5.0 wt.-%, or 21±2.5 wt.-%, or 24±12.5 wt.-%, or 24±10 wt.-%, or 24±7.5 wt.-%, or 24±5.0 wt.-%, or 24±2.5 wt.-%, or 27±12.5 wt.-%, or 27±10 wt.-%, or 27±7.5 wt.-%, or 27±5.0 wt.-%, or 27±2.5 wt.-%, or 29±10 wt.-%, or 29±7.5 wt.-%, or 29±5.0 wt.-%, or 29±2.5 wt.-%;
   in each case relative to the total weight of the curable composition, the total weight of the thermally conductive nano-filler and the total weight of the thermally conductive macro-filler.

In preferred embodiments, the total weight content of the thermally conductive nano-filler, the another thermally conductive nano-filler and the thermally conductive macro-filler is
at least about 15 wt.-%, preferably at least about 25 wt.-%, more preferably at least about 35 wt.-%, still more preferably at least about 45 wt.-%; and/or
at most about 80 wt.-%, preferably at most about 75 wt.-%, more preferably at most about 70 wt.-%, still more preferably at most about 65 wt.-%;
within the range of from about 15 to 80 wt.-%, preferably from about 45 to 65 wt.-%, more preferably within the range of about 40±5.0 wt.-%, or 45±10 wt.-%, or 45±5.0 wt.-%, or 50±15 wt.-%, or 50±10 wt.-%, or 50±5.0 wt.-%, or 55±20 wt.-%, or 55±15 wt.-%, or 55±15 wt.-%, or 55±10 wt.-%, or 55±5.0 wt.-%, or 60±25 wt.-%, or 60±20 wt.-%, or 60±15 wt.-%, or 60±10 wt.-%, or 60±5.0 wt.-%, or 65±30 wt.-%, or 65±25 wt.-%, or 65±20 wt.-%, or 65±15 wt.-%, or 65±10 wt.-%, or 65±5.0 wt.-%.
   in each case relative to the total weight of the curable composition, the total weight of the thermally conductive nano-filler, the total weight of the thermally conductive macro-filler and the total weight of the another thermally conductive nano-filler.

In preferred embodiments, the curable composition according to the invention additionally comprises (v) a curing catalyst. Curing catalysts for humidity-curable prepolymers such as silyl-modified prepolymers are known to the skilled person and commercially available.

Preferably, the curing catalyst is selected from
carboxylates of metals, preferably of tin, zinc, iron, lead, and cobalt; preferably selected from the group consisting of dibutyltin dilaurate (DBTDL), dibutyltin diacetate, dioctyltin dilaurate, stannous acetate, stannous caprylate, lead naphthenate, zinc caprylate, cobalt naphthenate;
organic bases; preferably selected from the group consisting of ethyl amines, dibutyl amine, hexylamines, and pyridine;
inorganic acids; preferably sulfuric acid or hydrochloric acid; and
organic acids; preferably selected from the group consisting of toluene sulfonic acid, acetic acid, stearic acid and maleic acid.

Preferably, the weight content of the curing catalyst is
at least about 0.1 wt.-%, preferably at least about 0.3 wt.-%; and/or
at most 2.0 wt.-%, preferably at most 1.5 wt.-%; and/or
within the range of from about 0.1 to 2.0 wt.-%, preferably from about 0.3 to 1.5 wt.-%;
   in each case relative to the total weight of the curable composition.

In preferred embodiments, the curable composition according to the invention additionally comprises (vi) a silane compatibilizer. Silane compatibilizers are known to the skilled person and commercially available.

Preferably, the silane compatibilizer is a functional silane.

Preferably, the silane compatibilizer is
an amino silane, preferably a diamino-functional silane or a multifunctional aminosilane, more preferably N-2-aminoethyl-3-aminopropyltrimethoxysilane (DAMO); or a bifunctional silane possessing a reactive primary amino group and hydrolyzable ethoxysilyl groups, more preferably 3-aminopropyltriethoxysilane (AMEO);
a vinyl silane, preferably a bifunctional organosilane possessing a vinyl group and a hydrolyzable trimethoxysilyl group (VTMO) or a bifunctional organosilane possessing a vinyl group and a hydrolyzable 2-methoxy-ethoxy-silyl group (VTMOEO);
a mixture thereof.

Preferably, the silane compatibilizer comprises a hydrolyzable group and a nonhydrolyzable group.

Preferably, the hydrolyzable group is a hydrolyzable silyl group as defined above with regard to the preferred embodiments of the silyl-modified prepolymer according to the invention.

Preferably, the nonhydrolyzable group is selected from —C₁₋₁₂-alkyl, —CH═CH₂, —NH₂, —NHC₁₋₁₂-alkyl, and —N(C₁₋₁₂-alkyl)₂.

Preferably, the weight content of the silane compatibilizer is
at least 0.05 wt.-%, preferably at least 0.10 wt.-%, more preferably at least 0.15 wt.-%, still more preferably at least 0.2 wt.-%, yet more preferably at least 0.25 wt.-%, even more preferably at least 0.3 wt.-%, most preferably at least 0.4 wt.-%, and in particular at least 0.5 wt.-%; and/or
at most 6.0 wt.-%, preferably at most 5.5 wt.-%, more preferably at most 5.0 wt.-%, still more preferably at most 4.5 wt.-%, yet more preferably at most 4.0 wt.-%, even more preferably at most 3.5 wt.-%, most preferably at most 3.0 wt.-%, and in particular at most 2.5 wt.-%; and/or
within the range of from about 0.05 wt.-% to 5.0 wt.-%, preferably from about 0.5 wt.-% to 2.5 wt.-%.
   in each case relative to the total weight of the curable composition.

In preferred embodiments, the curable composition according to the invention additionally comprises (vii) a polyol plasticizer. Suitable polyol plasticizers are known to the skilled person and commercially available.

Preferably, the polyol plasticizer has a weight average molecular weight within the range of from about 2,000 to 20,000 g/mol.

Preferably, the polyol plasticizer is
selected from glycerol, sorbitol, ethylene glycol, diethylene glycol, triethylene glycol, tetraethylene glycol, polyethylene glycol, propylene glycol, dipropylene glycol, tripropylene glycol, tetrapropylene glycol, and polypropylene glycol;
an esterified polyol plasticizer, preferably an ester of a polyol of two to five carbon atoms and one or more aliphatic saturated organic acids;
a polycarbonate polyol which may either be predominately or exclusively amorphous or crystalline;
a polyester polyol which may either be predominately or exclusively amorphous or crystalline;
a polyol grafted to polymeric particles, preferably grafted to styrene-acrylonitrile copolymer particles (SAN);
polyols with copolymeric structure, preferably accounting for different chemical structures and polarities, preferably detergent-like structures to allow compatibilizing effects; or
any mixture of any of the foregoing.

Polycarbonate polyols are particularly preferred.

Preferred polycarbonate polyols are derived from (e.g. are the reaction products of)
an alkylene oxide, preferably ethylene oxide or propylene oxide, more preferably propylene oxide;
carbon dioxide; and
a diol, dicarboxylic acid, triol, tricarboxylic acid, tetrol or tetracarboxylic acid; hydroxycarboxylic acids are also contemplated.

A typical reaction scheme involving reaction of a diol (m=2), triol (m=3) or tetrol (m=4) can be illustrated as follows:

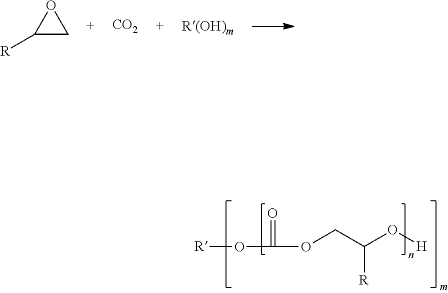

Preferably, R is —H or —CH₃, whereas R′ is preferably an aromatic or aliphatic scaffold structure. A skilled person recognizes that integer n may individually vary for each branch m. Preferably, integer n is independently of one another within the range of from 1 to 50, more preferably 2 to 20.

Other preferred polycarbonate polyols are derived from (e.g. are the reaction products of)
an activated carbonic acid, preferably phosgene or carbonic acid dimethylester; and
a diol, optionally in admixture with a triol and/or a tetrol.

A typical reaction scheme involving reaction of a diol can be illustrated as follows:

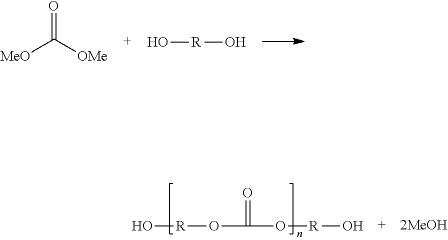

Preferably, integer n is within the range of from 1 to 50, more preferably 2 to 20.

Examples of polyols with copolymeric structure, preferably accounting for different chemical structures and polarities, preferably detergent-like structures to allow compatibilizing effects, include but are not limited to nonionic surfactants derived from polyoxyethylenes such as poloxamers, polyoxyethylene alkyl ethers, polyoxyethylene fatty acid esters, ethoxylated amines, ethoxylated fatty acid amides, polyoxyethylene sorbitan monofatty acid esters, polyoxyethylene sorbitan difatty acid esters, polyoxyethylene sorbitan trifatty acid esters, and the like.

Preferably, the polyol plasticizer comprises or essentially consist of a copolymer polyol, preferably a copolymer of a polymeric material grafted onto a main polyol chain, more preferably a SAN (styrene/acrylonitrile) or an AN (acrylonitrile) grafted onto a polyether polyol or onto a polyester polyol.

Preferably, the polyol plasticizer comprises or essentially consist of a SAN (styrene/acrylonitrile) grafted onto a polyol.

In preferred embodiments, the polyol is a polyether polyol selected from polyoxymethylene, polyoxyethylene, polyoxypropylene, and polyoxybutylene.

In preferred embodiments, the polyol is a polyester polyol, preferably an ester of a polyol of two to five carbon atoms and one or more aliphatic saturated organic acids.

Preferably, the copolymer polyol is selected from the group consisting of SAN-grafted polyether polyols and SAN-grafted polyester polyols; preferably SAN-grafted polyoxymethylene, SAN-grafted polyoxyethylene, SAN-grafted polyoxypropylene, and SAN-grafted polyoxybutylene.

In preferred embodiments, the polyol plasticizer comprises or essentially consists of a mixture of polycarbonate polyol and polyol grafted to polymeric particles, preferably grafted to styrene-acrylonitrile copolymer particles (SAN).

In preferred embodiments, the polyol plasticizer has a weight average molecular weight
of at least about 100,000 g/mol, preferably at least about 120,000 g/mol, more preferably at least about 140,000 g/mol, still more preferably at least about 160,000 g/mol, yet more preferably at least about 180,000 g/mol, even more preferably at least about 200,000 g/mol, most preferably at least about 220,000 g/mol, and in particular at least about 240,000 g/mol; and/or
of at most about 500,000 g/mol, preferably at most about 480,000 g/mol, more preferably at most about 460,000 g/mol, still more preferably at most about 440,000 g/mol, yet more preferably at most about 420,000 g/mol, even more preferably at most about 400,000 g/mol, most preferably at most about 380,000 g/mol, and in particular at most about 360,000 g/mol; and/or
within the range of from about 100,000 to 500,000 g/mol.

Preferably, the weight content of the polyol plasticizer is
at least 0.05 wt.-%, preferably at least 0.10 wt.-%, more preferably at least 0.15 wt.-%, still more preferably at least 0.2 wt.-%, yet more preferably at least 0.25 wt.-%, even more preferably at least 0.3 wt.-%, most preferably at least 0.4 wt.-%, and in particular at least 0.5 wt.-%; and/or
at most 6.0 wt.-%, preferably at most 5.5 wt.-%, more preferably at most 5.0 wt.-%, still more preferably at most 4.5 wt.-%, yet more preferably at most 4.0 wt.-%, even more preferably at most 3.5 wt.-%, most preferably at most 3.0 wt.-%, and in particular at most 2.5 wt.-%; and/or
within the range of from about 0.05 wt.-% to 5.0 wt.-%, preferably from about 0.5 wt.-% to 2.5 wt.-%;
   in each case relative to the total weight of the curable composition.

Preferably, the weight content of the polyol plasticizer is
at least 2.0 wt.-%, preferably at least 4.0 wt.-%, more preferably at least 6.0 wt.-%, still more preferably at least 8.0 wt.-%, yet more preferably at least 10 wt.-%, even more preferably at least 12 wt.-%, most preferably at least 15 wt.-%, and in particular at least 20 wt.-%; and/or
at most 43 wt.-%, preferably at most 40 wt.-%, more preferably at most 37 wt.-%, still more preferably at most 34 wt.-%, yet more preferably at most 31 wt.-%, even more preferably at most 28 wt.-%, most preferably at most 25 wt.-%, and in particular at most 22 wt.-%; and/or
within the range of from about 2.0 wt.-% to 40 wt.-%, preferably from about 8.0 wt.-% to 36 wt.-%;
   in each case relative to the total weight of the curable composition.

Depending upon the chemical nature of the humidity-curable prepolymer and its reactive functional groups, it may be preferred to use blocked polyol plasticizers to avoid undesirable reactions. For example, when the humidity-curable prepolymer comprises reactive isocyanate groups, the hydroxyl groups of the polyol plasticizer are preferably blocked, e.g. also with isocyanate groups.

It has been found that polyol plasticizers can improve strength, rheology, viscosity, plasticizing, quick-grab and other properties of the curable composition and/or cured composition. In particular, it has been surprisingly found that polyol plasticizers, such as polycarbonate polyols and other polyols, are not only useful as instant fix component like other crystalizing additives, but also serve as an exfoliation aid. Exfoliation is important with respect to thermal conduction and it is principally desirable to finely disperse the thermally conductive nano-filler in a non-agglomerated state within the curable composition and the cured composition, respectively. It has now been found that polycarbonate polyols and other polyols are particularly useful to exfoliate the thermally conductive nano-filler, e.g. graphene platelets, during mixing and curing. The presence of polycarbonate polyols or other polyols may either preserve the exfoliation level of the starting material (dry graphene) thereby preventing the graphene platelets to agglomerate in the final product, or it may even increase exfoliation of the thermally conductive nano-filler, e.g. graphene platelets, compared to the starting material (dry graphene).

Further, it has been surprisingly found that polyol plasticizers, such as polycarbonate polyols and other polyols and crystalizing additives, are useful as enhancer for improved compressibility in terms of compressive strength. Compressive strength is improved as a function of time, not only in the final cured state but also in the course of the curing process which typically lasts several minutes. While the curable composition prior to curing can be shaped and molded, the presence of polyol plasticizers, such as polycarbonate polyols and other polyols and crystalizing additives has the effect that a comparatively short period after curing has commenced, compressive strength of the curing composition is already improved and further increases in the course of ongoing curing until curing is complete.

In preferred embodiments, the curable composition according to the invention additionally comprises one or more additives selected from the group consisting of curing accelerators, adhesion promoters, stabilizers, colorants, pigments, fillers, toughening agents, impact modifiers, blowing agents, and moisture scavengers. These additives are known to the skilled person, commercially available and employed in conventional amounts.

Preferably, the additive is an adhesion promoter, preferably selected from the group consisting of glycidoxypropyltrimethoxy silane, aminoethyl-aminopropyl-trimethoxy silane, aminopropyl-triethoxy silane, hydrolyzed aminoethyl-aminopropylmethyldimethoxy silane, aminopropyl-trimethoxy silane, and mixtures thereof.

Preferably, the additive is a moisture scavenger, preferably selected from vinyltrimethoxy silane, phenyltrimethoxy silane, and mixtures thereof.

Preferably, the additive is a filler.

In preferred embodiments, the filler is a spherical filler or isotropic filler which may be comparatively small or comparatively large. Preferred are fillers that allow for fixing anisotropic platelet-shaped particles, e.g. those of the thermally conductive nano-filler and/or the optionally present thermally conductive macro-filler in position and preventing anisotropic, unidirectional orientation thereof. Suitable spherical or isotropic fillers include but are not limited to polymeric particles, e.g. rubber, PVC, SAN, and the like, mineral fillers, ceramic fillers, glass beads, and other fillers suitable for fixing anisotropic platelet-shaped particles.

In other preferred embodiments, the filler is an anisotropic filler which may be comparatively small or comparatively large. Suitable anisotropic fillers include but are not limited to high-aspect ratio fillers such as fibers or needle-like minerals, e.g. needle quartz, mesolite, natrolite, malachite, gypsum, rutile, brochantite or bultfonteinite. As it would be less desirable to have an anisotropic orientation of the anisotropic filler within the composition, anisotropic fillers are preferably added by methods that provide isotropic orientation of anisotropic fillers such as mechanical spray application.

Preferably, the curable composition according to the invention has a Brookfield viscosity (ASTM D789, D4878) of at least about 5,000 mPa s, preferably at least about 10,000 mPa s, more preferably at least about 15,000 mPa s.

Preferably, the curable composition according to the invention has a Brookfield viscosity (ASTM D789, D4878) of at most about 600,000 mPa s, preferably at most about 500,000 mPa s, more preferably at most about 400,000 mPa s, still more preferably at most about 300,000 mPa s, yet more preferably at most about 200,000 mPa s, even more preferably at most about 100,000 mPa s, most preferably at most about 75,000 mPa s, and in particular at most about 50,000 mPa s.

Preferably, the curable composition according to the invention has a Brookfield viscosity (ASTM D789, D4878) within the range from about 5,000 to 600,000 mPa s, preferably from about 10,000 to 500,000 mPa s, more preferably from about 15,000 to 400,000 mPa s.

Preferably, the curable composition according to the invention has an open time within the range of from about 5.0 to 40 minutes, wherein the open time is determined by means of a spatula in contact to the curing composition. When no material of the curing composition is transferred to the spatula anymore, this is defined as the open time. Typically, the spatula is made from stainless steel.

Preferably, the curable composition according to the invention has a handling time to reach a lap shear strength of 0.5 MPa determined according to ASTM/EN ISO DIN 53504 within the range of from about 0.5 to 8 hours.

Preferably, the curable composition according to the invention has a curing time of at least about 3 mm/24 h, wherein the curing time is determined by applying a bead of the curable composition, cutting the bead, and measuring the thickness of the cut bead skin over time. The applied bead has a diameter typically within the ranges of from 1.0 to 5.0 cm.

In preferred embodiments, the curable composition according to the invention does not contain metallic filler.

In preferred embodiments, the curable composition according to the invention is foamable.

In order to render the curable composition foamable, it may contain a foaming agent (blowing agent, expansion agent) that upon activation is capable of autonomously induce a foaming process.

In a preferred embodiment, the curable composition comprises a foaming agent that is capable of releasing a gas, preferably CO₂ or N₂, by a chemical reaction and/or a physical process. Preferably, the composition and/or the foaming agent creates excess CO₂ by hydrolysis of isocyanates in the presence of excess moisture.

In another preferred embodiment, the curable composition comprises a foaming agent that is capable of releasing a liquid, preferably methanol, ethanol or isopropanol, by a chemical reaction and/or a physical process. Preferably, the composition and/or the foaming agent creates excess methanol, ethanol or isopropanol by hydrolysis of hydrolyzable silyl groups in the presence of excess moisture or excess hydroxy functionality.

In preferred embodiments, the curable composition comprises a physical blowing agent that is activatable at elevated temperature. It is further contemplated that foaming of the composition may be achieved by physical injection of a gas.

In preferred embodiments, the curable composition according to the invention upon foaming is capable of expanding its volume, preferably by at least 1.0 vol.-%, more preferably at least 2.5 vol.-%, still more preferably at least 5.0 vol.-%, yet more preferably at least 7.5 vol.-%, even more preferably at least 10 vol.-%, most preferably at least 12.5 vol.-%, in particular at least 15 vol.-%, in each case relative to the total volume of the foamable composition before foaming is induced. In preferred embodiments, the curable composition according to the invention upon foaming is capable of expanding its volume by at least 50 vol.-%, or at least 100 vol.-%, or at least 250 vol.-%, or at least 500 vol.-%, or at least 750 vol.-%, or at least 1000 vol.-%, or at least 1500 vol.-%, or at least 2000 vol.-%, or at least 3000 vol.-%, or at least 4000 vol.-%, in each case relative to the total volume of the foamable composition before foaming is induced.

Without wishing to be bound to any scientific theory, foaming the humidity-cured matrix material allows to re-arrange the thermally-conductive filler within the final cured product, from a more-or-less uni-directional orientation to a more random alignment seen on the average volume unit, which will increase overall conductivity across the material. While actually the fillers get even more aligned, they align to the surface of the spherical gas pocket or filler to result in an average isotropic alignment.

In preferred embodiments, the curable composition according to the invention is a one-component curable system. Thus, the composition according to the invention is preferably a ready-to use composition that already contains all ingredients that are needed for the desired purpose, except air humidity.

In particular, prior to use, the composition according to the invention does preferably not require any addition of further additives nor admixture with other compositions.

In other preferred embodiments, the curable composition according to the invention is a two-component curable composition, i.e. a system of two separate components. According to these embodiments, the first component of the curable two-component composition preferably comprises the total amount of the humidity-curable prepolymer, preferably together with the total amount or a fraction of the thermally conductive nano-filler, and/or the total amount or a fraction of the thermally conductive macro-filler. The second component of the curable two-component composition is preferably an aqueous composition, preferably comprising the total amount or a fraction of the thermally conductive nano-filler, and/or the total amount or a fraction of the thermally conductive macro-filler.

The relative weight or volume ratio of the two components of the two-component curable composition according to the invention are not particularly limited and are preferably within the range of from about 10:1 to 1:10, such as about 10:1, 5:1, 1:1, 1:5 or 1:10. Cartridge systems taking account of different volumes of the two components are commercially available and contain mixing chambers properly admixing the first component and the second component immediately in front of the nozzle through which the admixed curable composition can be applied onto the substrate.

The one-component curable composition as well as the two-component curable composition according to the invention both have the advantages of a comparatively low density, tailored adhesion, and cartridge application possibility, whereas the two-component curable composition additionally gives the opportunity for fast curing due to the adjusted water content of the second component which is typically higher than the water content in humid air.

Another aspect of the invention relates to a cartridge system containing the curable composition according to the invention, preferably the one-component curable composition or the two-component curable composition.

Another aspect of the invention relates to a partially cured or cured composition obtainable by partially curing or curing the curable composition according to the invention as described above, preferably by subjecting the curable composition to air humidity and waiting until partial curing or curing has been completed.

The composition may be uncured, partially cured or cured. The key is that it provides the right physical and mechanical properties whether the composition is uncured, partially cured or cured. In certain embodiments, it can be advantageous when the composition is partially cured only so that it retains some curing capacity. This can be advantageous for providing sufficient rebonding to properly connect e.g. new replacement battery elements to cooling plates, without addition of further fresh curable composition. It is also contemplated to apply an activator such as water or a catalyst on the bottom of e.g. the replacement battery element, to aid the connection of the new battery element to the existing partially cured composition in order to induce further cure. The activator function may be aided by the increase in cell temperature associated with battery element charging/operation.

When the composition is only partially cured, the state of partial curing is preferably stable under the given conditions and circumstances, e.g. because during partial curing the amount of water supplied to the curable composition, e.g. by air humidity, was insufficient in order to achieve full cure within the time period allowed for curing, and because subsequently, the thus partially cured composition was placed in an environment where it was not further subjected to air humidity, e.g. because the partially cured composition was encapsulated between to substrates without having access to air or any other humidity.

When curing is partial only, the degree of curing is not specifically limited. The degree of curing can be determined by methods that are known to the skilled person. In preferred embodiments, the degree of curing of the partially cured composition is at least about 10%, or at least about 25%, or at least about 50%, or at least about 75%, or at least about 90%. In other preferred embodiments, the degree of curing of the partially cured composition is at most about 90%, or at most about 75%, or at most about 50%, or at most about 25%, or at most about 10%.

Preferably, the partially cured or cured composition according to the invention has a thermal conductivity at 23° C. (ASTM E1530) of at least about 1.5 W·m⁻¹·K⁻¹, preferably at least about 2.0 W·m⁻¹·K⁻¹, more preferably at least about 2.5 W·m⁻¹·K⁻¹, still more preferably at least about 3.0 W·m⁻¹K⁻¹, yet more preferably at least about 3.5 W·m⁻¹·K⁻¹, even more preferably at least about 4.0 W·m⁻¹·K⁻¹, most preferably at least about 4.5 W·m⁻¹·K⁻¹, and in particular at least about 5.0 W·m⁻¹·K⁻¹.

Preferably, the partially cured or cured composition according to the invention has an electrical resistivity at 23° C. determined according to ASTM D5682—18 of at least about 10⁶ Ω·m, preferably at least about 10⁷ Ω·m, more preferably at least about 10⁸ Ω·m, still more preferably at least about 10⁹ Ω·m, yet more preferably at least about 10¹⁰ Ω·m.

Preferably, the partially cured or cured composition according to the invention has a density at 23° C. determined according to ASTM D792—20 of at most about 1.80 g·cm⁻³, preferably at most about 1.75 g·cm⁻³, more preferably at most about 1.70 g·cm⁻³, still more preferably at most about 1.65 g·cm⁻³, yet more preferably at most about 1.60 g·cm⁻³.

Preferably, the partially cured or cured composition according to the invention has a slippage resistance within the range from about 0 to 2.0 mm, wherein the slippage resistance is determined by using a conventional lap shear test set up, in a vertical arrangement, with a weight applied to the lower substrate. Displacement is then measured over time.

Preferably, the partially cured or cured composition according to the invention has a tensile strength determined according to ASTM/EN ISO DIN 53504 of at least about 4.5 MPa.

Preferably, the partially cured or cured composition according to the invention has an elongation determined according to DIN EN ISO 527 of at least about 200%, preferably at least about 250%, more preferably at least about 300%, still more preferably at least about 350%, yet more preferably at least about 400%.

Preferably, the partially cured or cured composition according to the invention has an E-modulus determined according to DIN EN ISO 527 of at least about 2.0 MPa, preferably at least about 2.5 MPa, more preferably at least about 3.0 MPa, still more preferably at least about 3.5 MPa, yet more preferably at least about 4.0 MPa.

In preferred embodiments, the partially cured or cured composition according to the invention has an adhesiveness towards aluminum greater than towards a thermoplastic polymer, preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

In other preferred embodiments, the partially cured or cured composition according to the invention has an adhesiveness towards aluminum less than towards a thermoplastic polymer, preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

In preferred embodiments, the partially cured or cured composition according to the invention is a foam, i.e. comprises open or closed voids that are filled with air or a gas and/or a liquid.

Another aspect of the invention relates to an electric power supply for a vehicle comprising
a cooling plate; and
a casing of a battery element;
   wherein a partially cured or cured composition is disposed between the cooling plate and a part of the casing of the battery element; and
   wherein
the partially cured or cured composition is a partially cured or cured composition according to the invention as described above; and/or
the adhesion of the partially cured or cured composition towards the cooling plate is (i) greater than or (ii) less than towards the part of the casing of the battery element.

Preferably, upon pulling the casing of the battery element from the cooling plate, adhesive failure of the partially cured or cured composition occurs at an interface of the partially cured or cured composition and the part of the casing of the battery element such that the partially cured or cured composition remains adhered to the cooling plate, whereas the casing of the battery element is separated.

Preferably, adhesive failure occurs to an extent of at least about 80%, preferably at least about 90%, more preferably about 100%.

In preferred embodiments, the bottom of the battery element is equipped with a decompatibilizer, at the point of original assembly, to facilitate easy separation. Materials suitable as decompatibilizers are known to the skilled person and include but are not limited to teflon (tetrafluoroethylene) or film coatings made of oily or waxy materials.

Preferably,
the cooling plate comprises or essentially consists of a metal, preferably aluminum; and/or
the part of the casing of the battery element comprises or essentially consists of a thermoplastic polymer; preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

Preferably,
the battery element is a battery module, the cooling plate is a module cooling plate, and the partially cured or cured composition is a cell to module interface material; and/or
the battery element is a battery pack, the cooling plate is a pack cooling plate, and the partially cured or cured composition is a module to pack interface material.

Preferably, the cell to module interface material and/or the module to pack interface material (10) has a layer thickness within the range of from about 1.0 to 2.5 mm.

Another aspect of the invention relates to the use of a curable composition according to the invention as described above as an adhesive, preferably for adhering a part of a casing of a battery element to a cooling plate.

In preferred embodiments, after the curable composition has been allowed to partially cure or cure thereby obtaining a partially cured or cured composition, the adhesion of the partially cured or cured composition towards the cooling plate is greater than towards the part of the casing of the battery element. Preferably, after the curable composition has been allowed to partially cure or cure thereby obtaining a partially cured or cured composition, upon pulling the battery element from the cooling plate, adhesive failure of the partially cured or cured composition occurs at an interface of the partially cured or cured composition and the part of the casing of the battery element such that the partially cured or cured composition remains adhered to the cooling plate, whereas the battery element is separated. Preferably, adhesive failure occurs to an extent of at least about 80%, preferably at least about 90%, more preferably about 100%.

In other preferred embodiments, after the curable composition has been allowed to partially cure or cure thereby obtaining a partially cured or cured composition, the adhesion of the partially cured or cured composition towards the cooling plate is less than towards the part of the casing of the battery element. Preferably, after the curable composition has been allowed to partially cure or cure thereby obtaining a partially cured or cured composition, upon pulling the battery element from the cooling plate, adhesive failure of the partially cured or cured composition occurs at an interface of the partially cured or cured composition and the cooling plate such that the partially cured or cured composition remains adhered to the part of the casing of the battery element being separated. Preferably, adhesive failure occurs to an extent of at least about 80%, preferably at least about 90%, more preferably about 100%.

Preferably,
the cooling plate comprises or essentially consists of a metal, preferably aluminum; and/or
the part of the casing of the battery element comprises or essentially consists of a thermoplastic polymer; preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

Preferably,
the battery element is a battery module, the cooling plate is a module cooling plate, and the partially cured or cured composition is a cell to module interface material; and/or
the battery element is a battery pack, the cooling plate is a pack cooling plate, and the partially cured or cured composition is a module to pack interface material.

Preferably, the cell to module interface material and/or the module to pack interface material (10) has a layer thickness within the range of from about 1.0 to 2.5 mm.

Another aspect of the invention relates to a method for adhering a first substrate to a second substrate comprising the steps of
(a) contacting a surface of the first substrate and a surface of the second substrate with a curable composition according to the invention as described above; and
(b) allowing the curable composition to cure.

Preferably,
the first substrate is a part of a vehicle, preferably a cooling plate, more preferably a cooling plate comprising or essentially consisting of a metal, preferably aluminum; and
the second substrate is a part of a casing of a battery element, preferably a part of a casing of a battery element comprising or essentially consisting of a thermoplastic polymer; preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

Another aspect of the invention relates to a method for adhering a part of a casing of a battery element to a cooling plate by means of a curable composition comprising the steps of
(a) providing the curable composition;
(b) selecting the material of the part of the casing of the battery element and the material of the cooling plate such that after the curable composition has been allowed to partially cure or cure thereby obtaining a partially cured or cured composition, the adhesion of the partially cured or cured composition towards the cooling plate is (i) greater than or (ii) less than towards the part of the casing of the battery element;
(c) contacting a surface of the part of the casing of the battery element and a surface of the cooling plate with the curable composition; and
(d) allowing the curable composition to cure.

In preferred embodiments, in step (b) the material of the part of the casing of the battery element and the material of the cooling plate are selected such that after the curable composition has been allowed to partially cure or cure thereby obtaining a partially cured or cured composition, upon pulling the battery element from the cooling plate, adhesive failure of the partially cured or cured composition occurs at an interface of the partially cured or cured composition and the part of the casing of the battery element such that the partially cured or cured composition remains adhered to the cooling plate, whereas the battery element is separated. Preferably, adhesive failure occurs to an extent of at least about 80%, preferably at least about 90%, more preferably about 100%.

In other preferred embodiments, in step (b) the material of the part of the casing of the battery element and the material of the cooling plate are selected such that after the curable composition has been allowed to partially cure or cure thereby obtaining a partially cured or cured composition, upon pulling the battery element from the cooling plate, adhesive failure of the partially cured or cured composition occurs at an interface of the partially cured or cured composition and the cooling plate such that the partially cured or cured composition remains adhered to the part of the casing of the battery element being separated. Preferably, adhesive failure occurs to an extent of at least about 80%, preferably at least about 90%, more preferably about 100%.

According to the invention, the curable composition may be applied to the cooling plate, or to the part of the casing of the battery element. The adhesion may be greater towards either the cooling plate or the cell casing, regardless of which substrate the curable composition is applied to. Preferably, however, the adhesion is greater towards the substrate the curable composition is applied to first. Thus, it is contemplated that the curable composition is applied to a first of the two substrates selected from cooling plate and part of the casing of the battery element, and then partially or fully cured. Subsequently, the partially or fully cured composition at its side opposite of said first of the two substrate (i.e. either cooling plate or part of the casing of the battery element) is brought into contact with the second of the two substrates selected from cooling plate and part of the casing of the battery element. When proceeding along this sequence, the adhesive strength of the partially or fully cured composition towards the first substrate is typically greater than towards the second substrate.

Preferably, the curable composition is a curable composition according to the invention as described above.

Preferably,
the cooling plate comprises or essentially consists of a metal, preferably aluminum; and/or
the part of the casing of the battery element comprises or essentially consists of a thermoplastic polymer; preferably selected from the group consisting of polyamide, polyether, polyacetal, polyester, polycarbonate, polyacrylate, polyketone, polysulfide, polysulfone, polyolefine, and the blends or copolymers thereof, more preferably selected from polyethylene (PE), polypropylene (PP), polyoxymethylene (POM), polyether ether ketone (PEEK), polyetherketone (PEK), polyketone (PK), acrylonitrile butadiene styrene copolymer (ABS), polyphenylene sulfide (PPS), poly(p-phenylene oxide) (PPO), polysulfone (PSU), polybutylene terephthalate (PBT), and polyphthalamide (PPA).

Preferably,
the battery element is a battery module, the cooling plate is a module cooling plate, and the partially cured or cured composition is a cell to module interface material; and/or
the battery element is a battery pack, the cooling plate is a pack cooling plate, and the partially cured or cured composition is a module to pack interface material.

Preferably, the cell to module interface material and/or the module to pack interface material (10) has a layer thickness within the range of from about 1.0 to 2.5 mm.

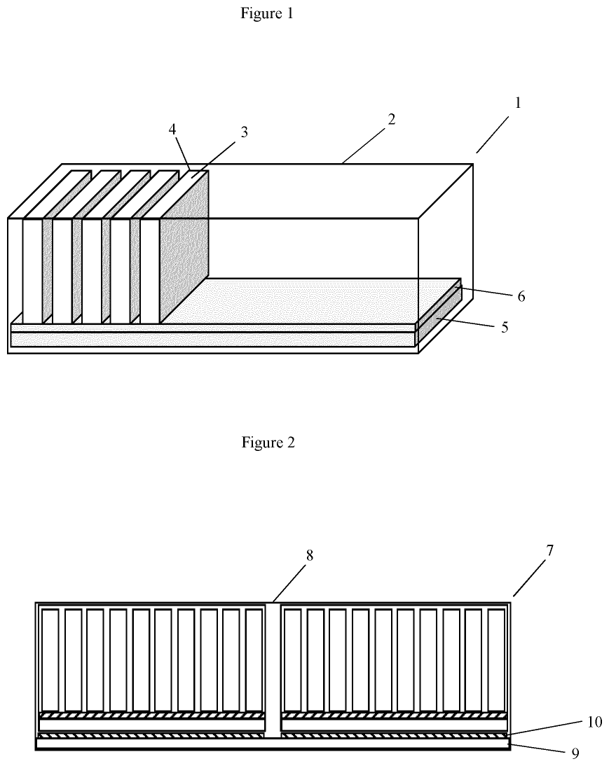

FIG. 1 is a schematic perspective view of a battery module (1) according to the invention comprising module casing (2) and a plurality of battery cells (3) each comprising a cell casing (4). Battery module (1) additionally comprises module cooling plate (5) to which the battery cells (3) are adhered by cell to module interface material (6), which preferably is the composition according to the invention in its curable or preferably in its cured state.

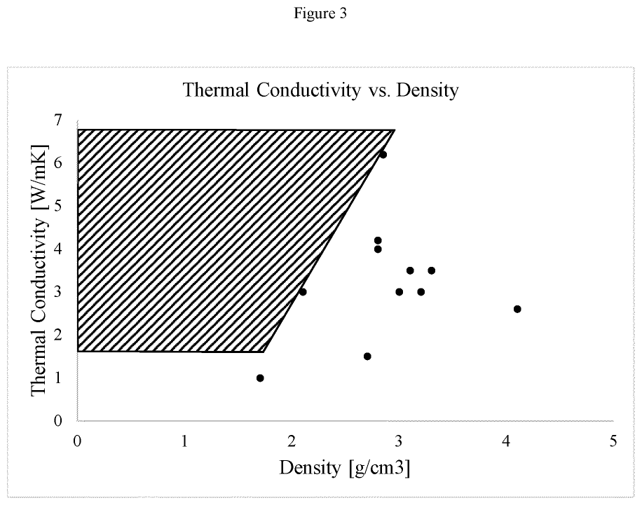

FIG. 2 is a schematic side view of a battery pack (7) according to the invention comprising a pack casing (8) and a multitude of battery modules, preferably of the type of battery modules (1) that are illustrated in FIG. 1. Battery pack (7) additionally comprises pack cooling plate (9) to which the battery modules are adhered by module to pack interface material (10), which preferably is the composition according to the invention in its curable or preferably in its cured state.

FIG. 3 illustrates by the hatched area the thermal conductivity vs. density as targeted by the present invention.

### LISTING OF REFERENCE NUMERALS

(1) battery module
(2) module casing
(3) battery cell
(4) cell casing
(5) module cooling plate
(6) cell to module interface material
(7) battery pack
(8) pack casing
(9) pack cooling plate
(10) module to pack interface material

The following examples further illustrate the invention but are not to be construed as limiting its scope:

The graphene that was employed in the examples in form of graphene nanoplatelets had the following properties:

| Property | Measurement | | Method |
|---|---|---|---|
| Bulk Density | <110 | kg/m³ | EN ISO 60 |
| Specific Surface Area | 282 | m²/g | BET Analysis |
| Planar Size (d50) | 40 | μm | Laser Diffraction |
| Average Thickness | 10 | nm | SEM |

| | | |
|---|---|---|
| Number of Layers | <30 | SEM |
| Carbon Content | 98% approx. | XPS |
| Oxygen Content | <1% approx. | XPS |

### Example 1—Influence of Plasticizer

Three samples with and without plasticizer were tested. The samples contained the following ingredients:

| [wt.-%] | 1-1 | 1-2 | 1-3 |
|---|---|---|---|
| silyl-modified prepolymer | 25.80 | 34.70 | 57.00 |
| graphene | 4.45 | 4.45 | 4.45 |
| calcium carbonate | 14.25 | 14.25 | 14.25 |
| polyol plasticizer | 17.82 | 8.91 | — |
| polycarbonate diol | 17.82 | 17.82 | 4.45 |
| SAN-grafted polyol | 17.82 | 17.82 | 17.82 |
| vinyltrimethoxy silane (VTMO) | 1.34 | 1.34 | 1.34 |
| N-2-aminoethyl-3- | 0.71 | 0.71 | 0.71 |
| aminopropyltrimethoxysilane (DAMO) | | | |

Thus, sample 1-1 differed from samples 1-2 and 1-3 only in the content of plasticizer. The amount of plasticizer was substituted in samples 1-2 and 1-3 with the corresponding amount of silyl-modified prepolymer in order to allow for meaningful conclusions so that differences in performance of the samples are directly attributable to the presence and absence of plasticizer.

A pull-off adhesion test was performed in accordance with ASTM D4541 with regard to improved rebonding after a first debonding on PET and aluminum. The results of the measurements are compiled in the following table:

| | | average | stress loss vs. |
|---|---|---|---|
| | test condition | [MPa] | 1st debonding |
| 1-1 | 1st debonding | 0.3 | — |
| | re-debonding after 1 h | 0.1 | 62% |
| | re-debonding after 13 days | 0.2 | 41% |
| 1-2 | 1st debonding | 0.5 | — |
| | re-debonding after 1 h | 0.0 | 98% |
| | re-debonding after 13 days | 0.0 | 95% |
| 1-3 | 1st debonding | 0.6 | — |
| | re-debonding after 1 h | 0.0 | 96% |
| | re-debonding after 13 days | 0.0 | 99% |

100% adhesive debonding on PET and full remaining on aluminum was observed

As demonstrated by the above comparative data, the sample 1-1 has significant advantages compared to samples 1-2 and 1-3 with respect to rebonding, thereby allowing 100% clean retrofit of new battery cells. This advantage is attributable to the plasticizer.

### Example 2—Influence of Thermally Conductive Nano-Filler and Thermally Conductive Macro-Filler

Six samples with and without graphene, aluminum oxide, boron nitride and/or calcium carbonate were tested. The samples contained the following ingredients:

| | inventive | | | | comparative | |
|---|---|---|---|---|---|---|
| [wt.-%] | 2-1 | 2-2 | 2-3 | 2-4 | 2-5 | 2-6 |
| silyl-modified prepolymer | 43.55 | 58.55 | 48.55 | 38.55 | 33.55 | 33.55 |
| graphene | 10.00 | 5.00 | 5.00 | 5.00 | — | — |
| aluminum oxide | — | — | 10.00 | 20.00 | 30.00 | 40.00 |
| boron nitride | 10.00 | — | — | — | — | — |
| calcium carbonate | 10.00 | 10.00 | 10.00 | 10.00 | 10.00 | — |
| polyol plasticizer | 2.50 | 2.50 | 2.50 | 2.50 | 2.50 | 2.50 |
| polycarbonate diol | 10.00 | 10.00 | 10.00 | 10.00 | 10.00 | 10.00 |
| SAN-grafted Polyol | 10.00 | 10.00 | 10.00 | 10.00 | 10.00 | 10.00 |
| vinyltrimethoxy silane | 3.00 | 3.0 | 3.0 | 3.0 | 3.0 | 3.0 |
| (VTMO) | | | | | | |
| N-2-aminoethyl-3- | 0.80 | 0.80 | 0.80 | 0.80 | 0.80 | 0.80 |
| aminopropyltrimethoxysilane | | | | | | |
| (DAMO) | | | | | | |
| tin catalyst | 0.15 | 0.15 | 0.15 | 0.15 | 0.15 | 0.15 |

Thus, inventive samples 2-1, 2-2, 2-3 and 2-4 differed from comparative samples 2-5 and 2-6 only in the content of thermally conductive nano-filler and/or type/content of thermally conductive macro-filler. The amount of thermally conductive nano-filler was substituted in comparative samples 2-5 and 2-6 with the corresponding amount of silyl-modified prepolymer and thermally conductive macrofiller, in order to allow for meaningful conclusions so that differences in performance of the samples are directly attributable to the presence and absence of thermally conductive nano-filler.

Thermal conductivity and density of the samples were measured in accordance with ASTM E1530 and ASTM D792—20, respectively. The results of the measurements are compiled in the following table:

| | inventive | | | | comparative | |
|---|---|---|---|---|---|---|
| | 2-1 | 2-2 | 2-3 | 2-4 | 2-5 | 2-6 |
| thermal conductivity [W/mK] | 3.50 | 1.01 | 1.82 | 2.07 | 1.57 | 1.08 |
| density [g/ml] | 1.23 | 1.17 | 1.46 | 1.76 | 1.99 | 2.20 |

As demonstrated by the above comparative data, the inventive samples 2-1, 2-2, 2-3 and 2-4 have significant advantages compared to comparative samples 2-5 and 2-6 with respect to thermal conductivity and density. This advantage is attributable to the thermally conductive nano-filler.

### Example 3—Influence of Polycarbonate Diol

Three samples with and without polycarbonate diol were tested. The samples contained the following ingredients:

| [wt.-%] | 3-1 | 3-2 | 3-3 |
|---|---|---|---|
| silyl-modified prepolymer | 28.55 | 38.55 | 32.55 |
| graphene | 10.00 | 10.00 | 10.00 |
| calcium carbonate | 17.00 | 17.00 | 17.00 |
| calcium carbonate (nano) | 28.00 | 28.00 | 33.50 |
| polycarbonate diol | 10 | — | — |
| diisononylphthalate (DINP) | 2.50 | 2.50 | 2.50 |
| vinyltrimethoxy silane (VTMO) | 3.00 | 3.00 | 3.00 |
| N-2-aminoethyl-3- | 0.80 | 0.80 | 0.80 |
| aminopropyltrimethoxysilane (DAMO) | | | |
| tin catalyst | 0.15 | 0.15 | 0.15 |

Thus, sample 3-1 differed from samples 3-2 and 3-3 only in the content of polycarbonate diol. The amount of polycarbonate diol was substituted in samples 3-2 and 3-3 with the corresponding amount of silyl-modified prepolymer and/or calcium carbonate in order to allow for meaningful conclusions so that differences in performance of the samples are directly attributable to the presence and absence of polycarbonate diol.

Thermal conductivity of samples 3-1, 3-2, and 3-3 was measured in accordance with ISO 22007-1. The results of the measurements are compiled in the following table:

| | 3-1 | 3-2 | 3-3 |
|---|---|---|---|
| thermal conductivity [W/mK] | 2.10 | 1.68 | 1.85 |

As demonstrated by the above comparative data, sample 3-1 has significant advantages compared to samples 3-2 and 3-3 with respect to thermal conductivity. This advantage is attributable to the polycarbonate diol.

### Example 4—Influence of Polycarbonate Diol

Three samples with and without polycarbonate diol were tested. The samples contained the following ingredients:

| Sample Name [wt.-%] | 4-1 | 4-2 | 4-3 |
|---|---|---|---|
| polycarbonate diol | — | 10.00 | 20.00 |
| SMP Prepolymer | 57.05 | 47.05 | 37.05 |
| diisononylphthalate (DINP) | 10.00 | 10.00 | 10.00 |
| calcium carbonate | 14.00 | 14.00 | 14.00 |
| graphene | 5.00 | 5.00 | 5.00 |
| vinyltrimethoxy silane (VTMO) | 3.00 | 3.00 | 3.00 |
| N-2-aminoethyl-3- | 0.80 | 0.80 | 0.80 |
| aminopropyltrimethoxysilane (DAMO) | | | |
| Sn catalyst | 0.15 | 0.15 | 0.15 |

Compressibility of the samples was measured in accordance with ASTM D575. The results of the measurements are compiled in the following table:

| Test speed = 15 mm/min | | 4-1 | 4-2 | 4-3 |
|---|---|---|---|---|
| | Curing Time | Stress at 0.5 mm gap | Stress at 0.5 mm gap | Stress at 0.5 mm gap |
| Material | [H] | [MPa] | [MPa] | [MPa] |
| 2 min | 0.001 | 0.0 | 0.0 | 0.0 |
| 15 min | 0.05 | 0.0 | 0.1 | 0.3 |
| 60 min | 1 | 0.2 | 0.5 | 0.9 |

As demonstrated by the above comparative data, the sample 4-1 has significant advantages compared to samples 4-2 and 4-3 with respect to compressibility. This advantage is attributable to the polycarbonate diol.

### Example 5—Influence of SAN-Grafted Polyol

Five samples with and without SAN-grafted polyol were tested. The samples contained the following ingredients:

| [wt.-%] | 5-1 | 5-2 | 5-3 | 5-4 | 5-5 |
|---|---|---|---|---|---|
| silyl-modified prepolymer | 42.85 | 47.85 | 47.85 | 52.85 | 24.35 |
| graphene | 15.00 | 10.00 | 20.00 | 15.00 | 10.00 |
| calcium carbonate | 17.00 | 17.00 | 17.00 | 17.00 | 50.50 |
| polycarbonate diol | 10.00 | 10.00 | 10.00 | 10.00 | 10.00 |
| SAN-grafted polyol | 10.00 | 10.00 | — | — | — |
| vinyltrimethoxy silane (VTMO) | 3.00 | 3.00 | 3.00 | 3.00 | 3.00 |
| N-2-aminoethyl-3- | 2.00 | 2.00 | 2.00 | 2.00 | 2.00 |
| aminopropyltrimethoxysilane | | | | | |
| (DAMO) | | | | | |
| tin catalyst | 0.15 | 0.15 | 0.15 | 0.15 | 0.15 |

Thus, samples 5-1 and 5-2 differed from samples 5-3, 5-4 and 5-5 only in the content of SAN-grafted polyol. The amount of SAN-grafted polyol was substituted in samples 5-3, 5-4 and 5-5 with the corresponding amount of silyl-modified prepolymer, graphene and/or calcium carbonate in order to allow for meaningful conclusions so that differences in performance of the samples are directly attributable to the presence and absence of SAN-grafted polyol.

Post cure performance was investigated in terms of elongation and E-modulus. Elongation and E-modulus were measured in accordance with DIN EN ISO 527. The results of the measurements are compiled in the following table:

| | 5-1 | 5-2 | 5-3 | 5-4 | 5-5 |
|---|---|---|---|---|---|
| elongation at break [%] | 360 | 420 | 417 | 300 | 66 |
| E-modulus [MPa] | 4.5 | 3.1 | 2.7 | 2.3 | 5.7 |

As demonstrated by the above comparative data, the samples 5-1 and 5-2 have significant advantages compared to samples 5-3, 5-4 and 5-5 with respect to elongation and E-modulus. This advantage is attributable to the SAN-grafted polyol.

1: A curable composition comprising
(i) humidity-curable prepolymer;
(ii) thermally conductive nano-filler selected from graphene, graphene oxide, carbon nanotubes and mixtures thereof; preferably having a particle size in the nanometer scale;
(iii) optionally, another thermally conductive nano-filler; preferably having a particle size in the nanometer scale; and
(iv) optionally, thermally conductive macro-filler; preferably having a particle size greater than the nanometer scale.

2: The curable composition according to claim 1, which is an adhesive.

3: The curable composition according to claim 1, which is capable of curing spontaneously at 23° C. upon contact with air humidity.

4: The curable composition according to claim claim 1, wherein the humidity-curable prepolymer is
a silyl-modified prepolymer; or
a humidity-curable polyurethane prepolymer; preferably a polyurethane homopolymer or polyurethane-urea copolymer.

5: The curable composition according to claim 4, wherein the silyl-modified prepolymer comprises a polymeric backbone and one or more hydrolyzable silyl groups.

6: The curable composition according to claim 4, wherein the silyl-modified prepolymer
has two ends and is terminated with one or more hydrolyzable silyl groups on one end (semi-telechelic) or on both ends (telechelic); preferably on two ends; and/or
has side chains carrying one or more hydrolyzable silyl groups.

7: The curable composition according to claim 5, wherein hydrolysis of at least one of the one or more hydrolyzable silyl groups leads to the formation of a silanol group.

8: The curable composition according to claim 7, wherein the condensation of the silanol group with another silanol group or with a hydrolyzable silyl group leads to the formation of a siloxane group.

9. (canceled)

10. (canceled)

11: The curable composition according to claim 5, wherein the one or more hydrolyzable silyl groups independently of one another are selected from the group consisting of monomethoxy silane groups, monoethoxy silane groups, dimethoxy silane groups, diethoxy silane groups, trimethoxy silane groups, and triethoxy silane groups.

12: The curable composition according to claim 5, wherein the one or more hydrolyzable silyl groups are covalently bonded to the polymeric backbone through spacers, wherein the spacers independently of one another selected from —C₁₋₁₂-alkylene-, —C₃₋₈-cycloalkylene-, -phenyl-, —C₁₋₆-alkylene-phenyl-, —C₁₋₆-alkylene-phenyl-C₁₋₆-alkylene-, —C(═O)C₁₋₆-alkylene-, —S(═O)₂C₁₋₆-alkylene-, —NH—C₁₋₆-alkylene-, —NHC(═O)—C₁₋₆-alkylene-, —C(═O)NHC₁₋₆-alkylene-, —NHS(═O)₂—C₁₋₆-alkylene-, —S(═O)₂NHC₁₋₆-alkylene-, —O—C₁₋₆-alkylene-, —OC(═O)—C₁₋₆-alkylene-, —C(═O)OC₁₋₆-alkylene-, —OS(═O)₂—C₁₋₆-alkylene-, —S(═O)₂OC₁₋₆-alkylene-, —OC(═O)NH—C₁₋₆-alkylene-, —NHC(═O)O—C₁₋₆-alkylene-, —OC(═O)O—C₁₋₆-alkylene-, —NHC(═O)NH—C₁₋₆-alkylene-, —O—[Si(CH₃)₂—O]₁₋₁₂—, azasilanes, and combinations thereof.

13-21. (canceled)

22: The curable composition according to claim 1, wherein the humidity-curable prepolymer is selected from the group consisting of dimethoxy-silyl-terminated polysulfone or copolysulfone, trimethoxy-silyl-terminated polysulfone or copolysulfone, dimethoxy-silyl-terminated polysulfone or copolysulfone in each case reinforced with silicone moieties, trimethoxy-silyl-terminated polysulfone or copolysulfone in each case reinforced with silicone moieties, hydrophobically modified dimethoxy-silyl-terminated polysulfone or copolysulfone, monofunctional dimethoxy-silyl-terminated polysulfone or copolysulfone, and monofunctional trimethoxy-silyl-terminated polysulfone or copolysulfone.

23. (canceled)

24. (canceled)

25: The curable composition according to claim 1, wherein the weight content of the humidity-curable prepolymer is
at least about 10 wt.-%, preferably at least about 20 wt.-%, more preferably at least about 30 wt.-%, still more preferably at least about 35 wt.-%; and/or
at most about 90 wt.-%, preferably at most about 80 wt.-%, more preferably at most about 70 wt.-%, still more preferably at most about 55 wt.-%; and/or
within the range of from about 10 to 90% wt.-%, preferably from about 20 to 80 wt.-%, more preferably from about 30 to 70 wt.-%, still more preferably from about 35 to 55 wt.-%;
in each case relative to the total weight of the curable composition.

26. The curable composition according to claim 5, wherein the thermally conductive nano-filler has
a thermal conductivity at 23° C. of at least about 2000 W·m⁻¹·K⁻¹, preferably at least about 2500 W·m⁻¹·K⁻¹, more preferably at least about 3000 W·m⁻¹·K⁻¹, still more preferably at least about 3500 W·m⁻¹·K⁻¹, yet more preferably at least about 4000 W·m⁻¹·K⁻¹; and/or
density of about 2.2±0.2 g·cm⁻³, preferably about 2.2±0.2 g·cm⁻³; and/or
bulk density of at most about 350 kg·m⁻³, preferably at most about 300 kg·m⁻³, more preferably at most about 250 kg·m⁻³, still more preferably at most about 200 kg·m⁻³, yet more preferably at most about 175 kg·m⁻³, even more preferably at most about 150 kg·m⁻³, most preferably at most about 125 kg·m⁻³, and in particular at most about 110 kg·m⁻³; and/or
an average particle size in the range of from about 1 nm to 900 nm; preferably within the range of about 10±5 nm, or 15±10 nm, or 20±15 nm, or 25±20 nm, or 50±40 nm, or 75±60 nm, or 100±75 nm, or 150±125 nm, or 200±150 nm, or 250±200 nm, or 300±250 nm, or 350±300 nm, or 400±350 nm, or 450±400 nm, or 500±450 nm; and/or
volume median diameter d50, determined by laser diffraction in accordance with ISO 13320:2020-01 and/or ASTM B822-20, within the range of from about 1.0 to 100 μm, preferably about 5.0 to 80 μm, more preferably about 10 to 70 μm, still more preferably about 15 to 65 μm, yet more preferably about 20 to 60 μm, even more preferably about 25 to 55 μm, most preferably about 30 to 50 μm, and in particular about 35 to 45 μm; and/or
a surface area of at least about 2000 m²·g⁻¹, preferably at least about 2200 m²·g⁻¹; and/or
surface area of at least about 100 m²·g⁻¹, preferably at least about 150 m²·g⁻¹, more preferably at least about 200 m²·g⁻¹, still more preferably at least about 225 m²·g⁻¹, yet more preferably at least about 250 m²·g⁻¹, even more preferably at least about 260 m²·g⁻¹, most preferably at least about 270 m²·g⁻¹, and in particular at least about 280 m²·g⁻¹; and/or
average thickness, determined by scanning electron microscopy (SEM), within the range of from about 0.4 to 40 nm, preferably about 0.6 to 30 nm, more preferably about 0.8 to 25 nm, still more preferably about 1.0 to 20 nm, yet more preferably about 2.0 to 18 nm, even more preferably about 4.0 to 16 nm, most preferably about 6.0 to 14 nm, and in particular about 8.0 to 12 nm; and/or
number of layers, determined by scanning electron microscopy (SEM), of at most about 100, preferably at most about 80, more preferably at most about 60, still more preferably at most about 50, yet more preferably at most about 45, even more preferably at most about 40, most preferably at most about 35, and in particular at most about 30; and/or
carbon content, determined by x-ray photoelectron spectroscopy (XPS), of at least about 80%, more preferably at least about 85%, still more preferably at least about 90%, yet more preferably at least about 95%, even more preferably at least about 96%, most preferably at least about 97%, and in particular at least about 98%; and/or
oxygen content, determined by x-ray photoelectron spectroscopy (XPS), of at most about 5.0%, more preferably at most about 4.0%, still more preferably at most about 3.0%, yet more preferably at most about 2.5%, even more preferably at most about 2.0%, most preferably at most about 1.5%, and in particular at most about 1.0%.

27: The curable composition according to claim 1, wherein the weight content of thermally conductive nano-filler is
at least about 0.1 wt.-%, preferably at least about 0.5 wt.-%, more preferably at least about 1.0 wt.-%, still more preferably at least about 2.5 wt.-%; and/or
at most about 10 wt.-%, preferably at most about 7.5 wt.-%, more preferably at most about 6.0 wt.-%, still more preferably at most about 5.0 wt.-%;
within the range of from about 0.1 to 10 wt.-%, preferably from about 0.5 to 7.5 wt.-%, more preferably from about 1.0 to 6.0 wt.-%, still more preferably from about 2.5 to 5.0 wt.-%, yet more preferably within the rage of about 1.0±0.5 wt.-%, or 1.5±1.0 wt.-%, or 2.0±1.5 wt.-%, or 2.5±2.0 wt.-%, or 3.0±2.5 wt.-%, or 3.5±3.0 wt.-%, or 4.0±3.5 wt.-%, or 4.5±4.0 wt.-%, or 5.0±4.5 wt.-%;
in each case relative to the total weight of the curable composition and the total weight of the thermally conductive nano-filler.

28: (canceled)

29: The curable composition according to claim 1, wherein the graphene is selected from
an allotrope of carbon, whose structure is one-atom-thick planar sheets of sp²-bonded carbon atoms that are densely packed in a honeycomb crystal lattice;
graphene nanoplatelets;
graphene nanoribbons; and
graphene nano-onions;
preferably wherein the curable composition comprises graphene but essentially no graphene oxide.

30: The curable composition according to claim 29, which comprises another thermally conductive nan-filler; preferably wherein the another thermally conductive nano-filler is
a nitride, preferably a covalent nitride, more preferably selected from the group consisting of boron nitride (BN), aluminum nitride (AlN), gallium nitride (GaN), indium nitride (InN), carbon nitride (C₃N₄), silicon nitride (Si₃N₄), germanium nitride (Ge₃N₄), tin nitride (Sn₃N₄), phosphorous nitride (P₃N₅), and copper nitride (Cu₃N);
an oxide, preferably selected from the group consisting of aluminum oxide (Al₂O₃), zinc oxide (ZnO), beryllium oxide (BeO), calcium oxide (CaO), magnesium oxide (MgO), iron oxide (Fe₂O₃), and silicon oxide (SiO₂);
a carbide, preferably selected from silicon carbide (SiC), titanium carbide (TiC), and tungsten carbide (WC);
a hydroxide, preferably selected from the group consisting of aluminum trihydrate (Al(OH)₃), magnesium hydroxide (Mg(OH)₂);
a carbonate, preferably selected from the group consisting of magnesium carbonate (MgCO₃), calcium carbonate (CaCO₃), strontium carbonate (SrCO₃), and barium carbonate (BaCO₃);
graphite;
or a mixture of any of the foregoing;
preferably calcium carbonate.

31-63. (canceled)

64: The curable composition according to claim 1, which has
an open time determined according to the description within the range of from about 5.0 to 40 minutes; and/or
a handling time to reach a lap shear strength of 0.5 MPa determined according to ASTM/EN ISO DIN 53504 within the range of from about 0.5 to 8 hours;
and/or
a curing time determined according to the description of at least about 3 mm/24 h.

65. (canceled)

66: The curable composition according to claim 64, which is foamable.

67-73. (canceled)

74: A partially cured or cured composition obtainable by partially curing or curing the curable composition according to claim 1.

75-77. (canceled)

78: An electric power supply for a vehicle comprising:
a cooling plate; and
a casing of a battery element; wherein a partially cured or cured composition is disposed between the cooling plate and a part of the casing of the battery element; and wherein
the partially cured or cured composition is a partially cured or cured composition according to claim 74; and/or
the adhesion of the partially cured or cured composition towards the cooling plate is (i) greater than or (ii) less than towards the part of the casing of the battery element.

79-101. (canceled)
